(19) United States
(12) Patent Application Publication
(10) Pub. No.: US 2025/0239013 A1
(43) Pub. Date: Jul. 24, 2025

(54) DATA PROCESSING METHOD AND APPARATUS FOR VIRTUAL SCENE

(71) Applicant: Tencent Technology (Shenzhen) Company Limited, Shenzhen (CN)

(72) Inventors: Xin Liu, Shenzhen (CN); Feng Ai, Shenzhen (CN); Jia Li, Shenzhen (CN)

(21) Appl. No.: 19/173,424

(22) Filed: Apr. 8, 2025

Related U.S. Application Data
(63) Continuation of application No. PCT/CN2024/083899, filed on Mar. 26, 2024.

(30) Foreign Application Priority Data
Apr. 14, 2023 (CN) 202310442543.8

(51) Int. Cl. G06T 17/00

(52) U.S. Cl. CPC G06T 17/00

(57) ABSTRACT

A data processing method and apparatus for a virtual scene are disclosed. The method comprises: displaying a virtual scene comprising an entity object. The method also comprises determining a source space and a destination space for transferring the entity object. The method also comprises performing proxy creation on the entity object in the source space to obtain a first entity replica of the entity object and performing proxy creation on the entity object in the destination space to obtain a second entity replica of the entity object. Further, the method comprises performing authorization transfer on the first entity replica and the second entity replica to obtain a first transferred entity replica and a second transferred entity replica, and performing proxy recycle on the first transferred entity replica and the second transferred entity replica.

### CROSS-REFERENCE TO RELATED APPLICATIONS

This application is a continuation application of PCT Application PCT/CN2024/083899, filed Mar. 26, 2024, which claims priority to Chinese Patent Application No. 202310442543.8 filed on Apr. 14, 2023, each entitled “DATA PROCESSING METHOD AND APPARATUS FOR VIRTUAL SCENE, ELECTRONIC DEVICE, STORAGE MEDIUM, AND PROGRAM PRODUCT”, and each of which is incorporated herein by reference in its entirety.

### FIELD OF THE TECHNOLOGY

This application relates to computer technologies, and in particular, to a data processing method and apparatus for a virtual scene, an electronic device, a storage medium, and a program product.

### BACKGROUND OF THE DISCLOSURE

A display technology based on graphics processing hardware extends channels for sensing an environment and obtaining information. Especially, a display technology for a virtual world (for example, a virtual scene displayed in a metaverse, or a virtual scene displayed in a game application) can implement diverse movement of virtual objects controlled by users or artificial intelligence according to actual application requirements, and has various typical application scenarios. For example, in a virtual scene of a game, a process of interaction between virtual objects can be simulated.

In the related art, in a game application in which a seamless big world is applied, full data of a real role is transmitted to a server on which a ghost role is located, and switching between the real role and the ghost role is performed on the server to transfer an entity object. However, this solution of transferring an entity object by packaging full data is prone to various errors, and cannot ensure effectiveness of entity object transfer.

### SUMMARY

This application provides a data processing method and apparatus for a virtual scene, an electronic device, a computer-readable storage medium, and a computer program product, to improve effectiveness of entity object transfer in the virtual scene.

Technical solutions in this application may be implemented as follows. For example, this application provides a data processing method for a virtual scene, performed by a computing device. The method comprises: displaying a virtual scene comprising an entity object, and determining a source space and a destination space for transferring the entity object. In addition, the method comprises performing proxy creation on the entity object in the source space to obtain a first entity replica of the entity object, and performing proxy creation on the entity object in the destination space to obtain a second entity replica of the entity object. Behavior data of the second entity replica can be synchronized with behavior data of the first entity replica. The method further comprises performing authorization transfer on the first entity replica and the second entity replica to obtain a first transferred entity replica and a second transferred entity replica, and performing proxy recycle on the first transferred entity replica and the second transferred entity replica.

The examples of this application provide a data processing apparatus for a virtual scene, including: an obtaining module, configured to display a virtual scene, the virtual scene including an entity object, recognize the entity object from the virtual scene, and determine a source space and a destination space for transferring the entity object; a proxy creation module, configured to: perform proxy creation on the entity object in the source space to obtain a first entity replica of the entity object; and perform proxy creation on the entity object in the destination space to obtain a second entity replica of the entity object, behavior data of the second entity replica being synchronized with behavior data of the first entity replica; an authorization transfer module, configured to perform authorization transfer on the first entity replica and the second entity replica to obtain a first transferred entity replica and a second transferred entity replica; and a proxy recycle module, configured to perform proxy recycle on the first transferred entity replica and the second transferred entity replica.

The examples of this application provide an electronic device for transferring an entity object. The electronic device includes: a memory, configured to store a computer program or computer-executable instructions; and a processor, configured to implement the data processing method for a virtual scene provided in the examples of this application when executing the computer program or the computer-executable instructions stored in the memory. The examples of this application provide a computer-readable storage medium, having a computer program or computer-executable instructions stored therein, the data processing method for a virtual scene provided in the examples of this application being implemented when the computer program or the computer-executable instructions are executed by a processor.

The examples of this application provide a computer program product, including a computer program or computer-executable instructions, the data processing method for a virtual scene provided in the examples of this application being implemented when the computer program or the computer-executable instructions are executed by a processor.

The application have the following beneficial effects: In a proxy creation stage, a first entity replica and a second entity replica are created. In an authorization transfer stage, authorization transfer is performed on the first entity replica and the second entity replica. In a proxy recycle stage, proxy recycle is performed on a first transferred entity replica and a second transferred entity replica. An entity object transfer process is smoothed through the three stages: the proxy creation stage, the authorization transfer stage, and the proxy recycle stage. In this way, when a problem occurs during the entity object transfer process, a stage in which the problem occurs can be accurately located, to quickly resolve the problem and improve effectiveness of entity object transfer.

### BRIEF DESCRIPTION OF THE DRAWINGS

FIG. 1 is a schematic diagram of an application mode of a data processing method for a virtual scene according to an example of this application.

FIG. 2 is a schematic diagram of a structure of an electronic device for transferring an entity object according to an example of this application.

FIG. 3A to FIG. 3H are schematic flowcharts of a data processing method for a virtual scene according to an example of this application.

FIG. 4 is a schematic diagram of a metaverse virtual world according to an example of this application.

FIG. 5 is a state transition diagram of entity object transfer according to an example of this application.

FIG. 6 is a schematic flowchart of a proxy creation event according to an example of this application.

FIG. 7 is a schematic flowchart of polling of a proxy creation queue according to an example of this application.

FIG. 8 is a schematic flowchart of an authorization transfer event according to an example of this application.

FIG. 9 is a schematic flowchart of polling of a transfer queue according to an example of this application.

FIG. 10 is a diagram of a time sequence of authorization transfer of a client-controlled entity object according to an example of this application.

FIG. 11 is a schematic flowchart of a proxy recycle method according to an example of this application.

FIG. 12 is a schematic flowchart of polling of a proxy recycle queue according to an example of this application.

### DESCRIPTION OF EMBODIMENTS

To make the objectives, technical solutions, and advantages of this application clearer, the following describes this application in further detail with reference to the accompanying drawings. The described examples are not to be considered as a limitation to this application. All other examples obtained by a person of ordinary skill in the art without creative efforts shall fall within the protection scope of this application.

In the following descriptions, the terms “first” and “second” are merely intended to distinguish between similar objects rather than describe a specific order of objects. The terms “first” and “second” may, where permitted, be interchangeable in a particular order or sequence, so that the examples of this application described herein can be performed in an order other than that illustrated or described herein.

Unless otherwise defined, meanings of all technical and scientific terms used in this specification are the same as those usually understood by a person skilled in the art to which this application belongs. The terms used in this specification are merely intended to describe the objectives of the examples of this application, but are not intended to limit this application.

Before this application are further described in detail, the terms in this application are described, and the following explanations are applicable to the terms in this application.
(1) In response to: It is configured for representing a condition or a state on which an operation to be performed depends. When the dependent condition or state is met, one or more operations may be performed in real time or with a specified delay. An order of performing a plurality of operations to be performed is not limited, unless otherwise specified.
(2) Client: It is an application that is run on a terminal to provide various services, for example, a video play client or a game client.
(3) Virtual scene: It is a virtual scene displayed (or provided) by an application when the application is run on a terminal. The virtual scene may be a simulated environment of a real world, or may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene. A dimension of the virtual scene is not limited in this application. For example, the virtual scene may include the sky, the land, or the ocean. The land may include environmental elements such as the desert and a city. A user may control a virtual object to move in the virtual scene.
(4) Virtual object: It is an image of any person or object that can perform interaction in a virtual scene, or a movable object in a virtual scene. The movable object may be a virtual character, a virtual animal, a cartoon character, or the like, for example, a character or an animal displayed in a virtual scene. The virtual object may be a virtual image configured for representing a user in the virtual scene. The virtual scene may include a plurality of virtual objects, and each virtual object has a shape and a volume in the virtual scene, and occupies some space in the virtual scene.
(5) Proxy object: It is a type of object that can inherit some or all of attributes and methods of a source object and that can add attributes and methods absent in the source object according to requirements of different applications.
(6) Entity object: It is a virtual object that objectively exists in a virtual scene and that can be distinguished from other virtual objects, for example, a house, clothes, a character, or an animal in the virtual scene.
(7) Entity replica: It is also referred to as a distributed entity object, and is an expression of an entity object that exists in different spaces of a virtual scene (for example, a metaverse or a game) application. For example, Iron Man in the metaverse is an entity object, and Iron Man existing in a plurality of parallel spaces of the metaverse is an entity replica.

The entity replica represents a concept of copying or duplicating an entity object in a virtual world. The entity replica is an accurate or approximate copy of an original entity object, and is configured for simulation, backup, testing, or other purposes in a virtual environment. The entity replica is similar to or the same as the original entity object to some extent, but exists independently without affecting an attribute or a state of the original entity object. Creating the entity replica in the virtual world can help a user perform experiments, operation simulation, multi-party communication, data backup, and the like, to improve flexibility and security of the virtual world. The entity replica plays an important role in the virtual world, provides the user with more manners of processing an entity object, and also provides more possibilities for management, collaboration, and operation of the virtual environment.
(8) Space: It represents a spatial area in a virtual scene (for example, metaverse) application.
(9) Server simulated proxy role: It is a role type of an entity replica. When a role of an entity replica on a server is the server simulated proxy role, behavior of the entity replica can only be passively synchronized with behavior of an entity replica whose role is an authority role on another server, and the entity replica of the server simulated proxy role cannot control its own actions.
(10) Authority role: It is a role type of an entity replica. When a role of an entity replica on a server is the authority role, the entity replica can control its own actions and synchronize its behavior to another entity replica.
(11) Metaverse: It is also referred to as a distributed world, and is a digital living space that is linked and created by scientific and technological means, maps the real world to an interactive virtual world, and has a new social system. The metaverse is a new virtuality and reality combined Internet application and social form generated by integrating a plurality of new technologies. The metaverse provides immersive experience based on an extended reality technology, generates an image of the real world based on a digital twin technology, and builds an economic system based on a blockchain technology, to closely integrate the virtual world and the real world in a social system, an identity system, and the like, and allow each user to produce and edit content.
(12) Seamless big world: It is a seamless big map. In a narrow sense, the seamless big world is a continuous and seamless map in which no loading is needed no matter in continuous outdoor scenes or direct entry/exit between outdoor and indoor scenes. In a broad sense, the seamless big world means that outdoor scenes are seamless and loading is needed between outdoor and indoor scenes. For example, in a game application, to create a large game world for a player and meet a gameplay requirement, the player may explore a big map. On a game server side, because a map size and a user scale supported by a single server are limited, a cluster may be constructed by using a plurality of game servers. When a user moves from one end of the big map to the other end, the user needs to span a plurality of game servers, and the user experiences no incoherence when exploring the big map.

This application provides a data processing method and apparatus for a virtual scene, an electronic device, a computer-readable storage medium, and a computer program product, to improve effectiveness of entity object transfer.

The data processing method for a virtual scene provided in the examples of this application may be implemented through entity object transfer. From a logical perspective, entity object transfer is to transfer an entity object from one space to another space. From a physical perspective, entity object transfer is to seamlessly transfer, to another physical node, a computer resource that is allocated to any entity replica on any physical node. The physical node is an entity object device in a computer network, for example, a network device such as a server, a router, or a switch.

For ease of understanding the data processing method for a virtual scene provided in the examples of this application, an application mode of the data processing method for a virtual scene provided in the examples of this application is first described. The data processing method for a virtual scene provided in the examples of this application may be jointly implemented by a terminal and a server.

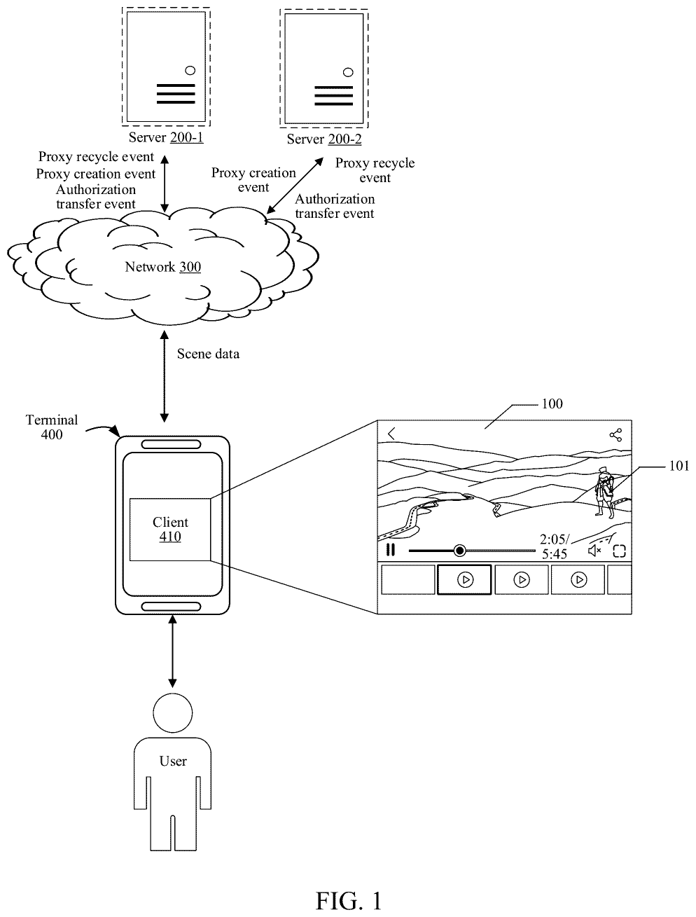

In an implementation scenario, FIG. 1 is a schematic diagram of an application mode of a data processing method for a virtual scene according to an example of this application. The method is applied to a terminal 400, a server 200-1, and a server 200-2. The server 200-1 and the server 200-2 communicate with the terminal 400 through a network 300.

In an example, the virtual scene 100 is a game scene. The server 200-1 is a server on which a source space in a game application is located, and the server 200-2 is a server on which a destination space in the game application is located. A player is a user using the game application, for example, a user watching a game or a user playing a game. Descriptions are provided below with reference to the foregoing example.

A player uses an account (e.g., a current account of the game application) to log in to the game application through the terminal 400. When an entity object 101 in the game application moves from the source space to the destination space in the virtual scene 100 and is at a specified distance from an area boundary between the source space and the destination space, a proxy creation event is triggered, proxy creation is performed on the entity object on the server 200-1 on which the source space is located to obtain a first entity replica of the entity object 101, and proxy creation is performed on the entity object on the server 200-2 on which the destination space is located to obtain a second entity replica of the entity object 101. Behavior data of the second entity replica is synchronized with behavior data of the first entity replica, and the first entity replica and the second entity replica correspond to the entity object. When the entity object 101 in the game application moves to the area boundary between the source space and the destination space, an authorization transfer event is triggered, authorization transfer is performed on the first entity replica on the server 200-1 on which the source space is located to obtain a first transferred entity replica, and authorization transfer is performed on the second entity replica on the server 200-2 on which the destination space is located to obtain a second transferred entity replica. When the entity object 101 in the game application moves to the destination space and is at a specified distance from the area boundary between the source space and the destination space, a proxy recycle event is triggered, proxy recycle is performed on the first transferred entity replica on the server 200-1 on which the source space is located, and proxy recycle is performed on the second transferred entity replica on the server 200-2 on which the destination space is located.

When loading of the game application is completed, the server 200-1 and the server 200-2 calculate, through graphics computing hardware (e.g., a type of graphics processing hardware includes a central processing unit (CPU) and a graphics processing unit (GPU)), scene data needed for display, complete loading, parsing, and rendering of display data, and output rendering data of the virtual scene to the terminal 400 through graphics output hardware. Visual perception of the virtual scene is formed on a human-computer interaction interface of the terminal 400. For example, a two-dimensional video frame is displayed on a display screen of a smartphone, or a video frame that achieves a three-dimensional display effect is projected to a lens of augmented reality/virtual reality glasses. In addition, to enrich perception effects, the terminal 400 may further form one or more of auditory perception, tactile perception, motion perception, and taste perception with assistance of different hardware.

In another example, the virtual scene 100 is a metaverse scene. The server 200-1 is a server on which a source space in a metaverse application is located, and the server 200-2 is a server on which a destination space in the metaverse application is located. Descriptions are provided below with reference to the foregoing example.

A user using the metaverse application (for example, a user watching a metaverse video) watches a metaverse video by using the terminal 400. When an entity object 101 in the virtual scene 100 displayed in the metaverse video enters, in the source space, a portal leading to the destination space, a proxy creation event is triggered, proxy creation is performed on the entity object on the server 200-1 on which the source space is located to obtain a first entity replica of the entity object 101, and proxy creation is performed on the entity object on the server 200-2 on which the destination space is located to obtain a second entity replica of the entity object 101. Behavior data of the second entity replica is synchronized with behavior data of the first entity replica, and the first entity replica and the second entity replica correspond to the entity object. During transfer of the entity object 101 in the portal, an authorization transfer event is triggered, authorization transfer is performed on the first entity replica on the server 200-1 on which the source space is located to obtain a first transferred entity replica, and authorization transfer is performed on the second entity replica on the server 200-2 on which the destination space obtain a second transferred entity replica. When the entity object 101 has been transferred to the destination space through the portal, a proxy recycle event is triggered, proxy recycle is performed on the first transferred entity replica on the server 200-1 on which the source space is located, and proxy recycle is performed on the second transferred entity replica on the server 200-2 on which the destination space is located.

When loading of the metaverse application is completed, the server 200-1 and the server 200-2 calculate, through graphics computing hardware (a type of graphics processing hardware includes a CPU and a GPU), scene data needed for display, complete loading, parsing, and rendering of display data, and output rendering data of the virtual scene to the terminal 400 through graphics output hardware. Visual perception of the virtual scene is formed on a display interface of the terminal 400. For example, a two-dimensional video frame is displayed on a display screen of a smartphone, or a video frame that achieves a three-dimensional display effect is projected to a lens of augmented reality/virtual reality glasses. In addition, to enrich perception effects, the terminal 400 may further form one or more of auditory perception, tactile perception, motion perception, and taste perception with assistance of different hardware.

In some examples, the terminal 400 may run a computer program to implement the data processing method for a virtual scene provided in the examples of this application. For example, the computer program may be a native program or a software module in an operating system. The computer program may be a native application (APP), to be specific, a program that needs to be installed in the operating system to run, for example, a dress-up game APP or a battle game APP; or may be a mini program that can be embedded into any APP, to be specific, a program that only needs to be downloaded to a browser environment to run. To sum up, the computer program may be an application, a module, or a plug-in in any form.

In some examples, the examples of this application may alternatively be implemented by using a cloud technology. The cloud technology is a hosting technology that integrates a series of resources such as hardware, software, and networks in a wide area network or a local area network to implement computing, storage, processing, and sharing of data.

For example, the server in FIG. 1 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be various types of user terminals, such as a notebook computer, a tablet computer, a desktop computer, a set-top box, a mobile device (for example, a mobile phone, a portable music player, a personal digital assistant, a dedicated messaging device, a portable gaming device, or an in-vehicle device), a smartphone, a smart speaker, a smart watch, a smart television, and an in-vehicle terminal, but is not limited thereto. The terminal 400 and the server may be directly or indirectly connected through wired or wireless communication. This is not limited in the examples of this application.

In some examples, a plurality of servers may constitute a blockchain, and the server is a node in the blockchain. There may be an information connection between nodes in the blockchain, and information may be transmitted between nodes through the information connection. Data (for example, logic of data processing for a virtual scene) related to the data processing method for a virtual scene provided in the examples of this application may be stored in the blockchain.

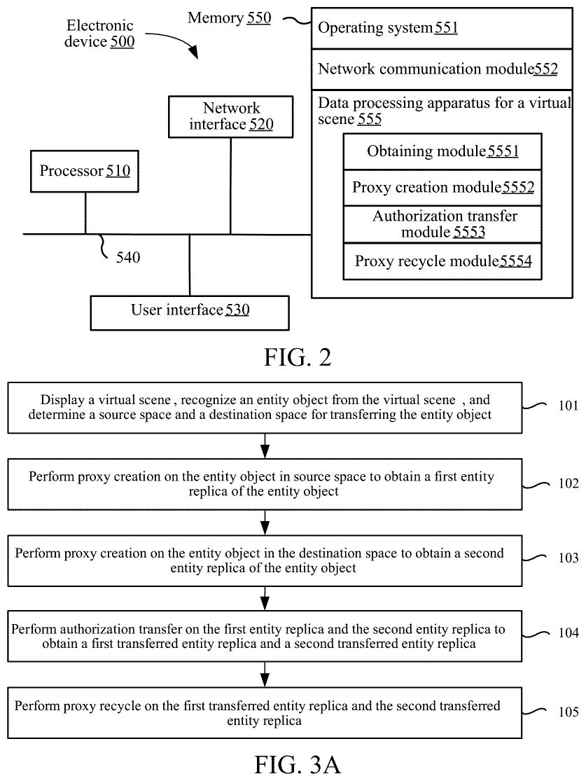

The following describes a structure of an electronic device for data processing for a virtual scene provided in the examples of this application. FIG. 2 is a schematic diagram of a structure of an electronic device 500 for data processing for a virtual scene according to an example of this application. The electronic device 500 may be a terminal or a server. The electronic device 500 for data processing for a virtual scene shown in FIG. 2 includes at least one processor 510, a memory 550, at least one network interface 520, and a user interface 530. The components in the electronic device 500 are coupled together through a bus system 540. The bus system 540 is configured to implement connection and communication between the components. In addition to a data bus, the bus system 540 further includes a power bus, a control bus, and a state signal bus. However, for clarity of description, all types of buses in FIG. 2 are marked as the bus system 540.

The processor 510 may be an integrated circuit chip with a signal processing capability, for example, a general-purpose processor, a digital signal processor (DSP), another programmable logic device, a discrete gate or transistor logic device, or a discrete hardware component. The general-purpose processor may be a microprocessor, any conventional processor, or the like.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in this application is intended to include any suitable type of memory. In some examples, the memory 550 includes one or more storage devices physically located away from the processor 510.

In some examples, the memory 550 is capable of storing data to support various operations. Examples of the data include a program, a module, and a data structure or a subset or superset thereof. Examples are described below:

An operating system 551 includes system programs for processing various basic system services and performing hardware-related tasks, for example, a framework layer, a kernel library layer, and a driver layer for implementing various basic services and process hardware-based tasks.

A network communication module 552 is configured to reach another electronic device through one or more (wired or wireless) network interfaces 520. For example, the network interface 520 includes Bluetooth, wireless fidelity (Wi-Fi), universal serial bus (USB), and the like.

In some examples, the data processing apparatus for a virtual scene provided in the examples of this application may be implemented by using software. The data processing apparatus for a virtual scene provided in the examples of this application may be provided as various software examples, including various forms such as an application, software, a software module, a script, or code.

FIG. 2 shows a data processing apparatus 555 for a virtual scene stored in the memory 550. The apparatus may be software in a form of a program, a plug-in, or the like, and includes a series of modules, including an obtaining module 5551, a proxy creation module 5552, an authorization transfer module 5553, and a proxy recycle module 5554. These modules are logical modules, and therefore may be combined in different manners or further split based on implemented functions. Functions of the modules are described below.

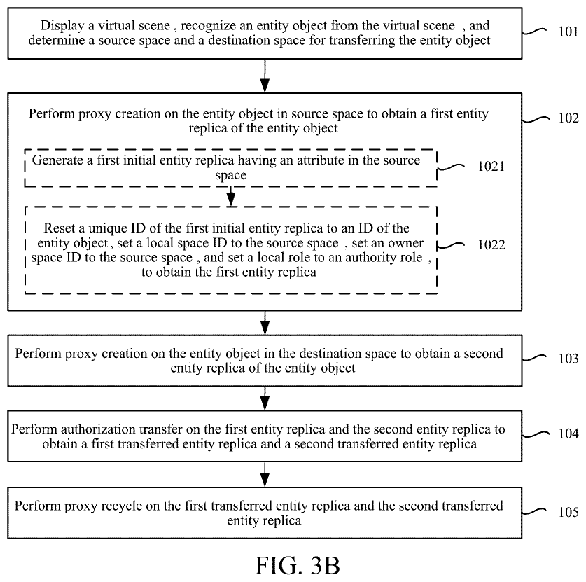

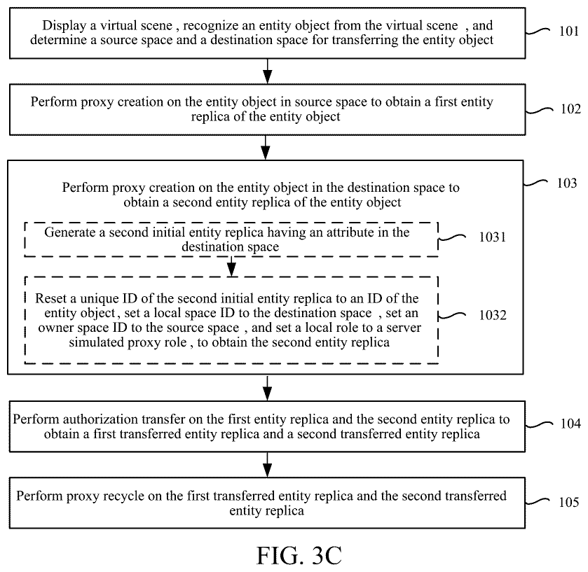

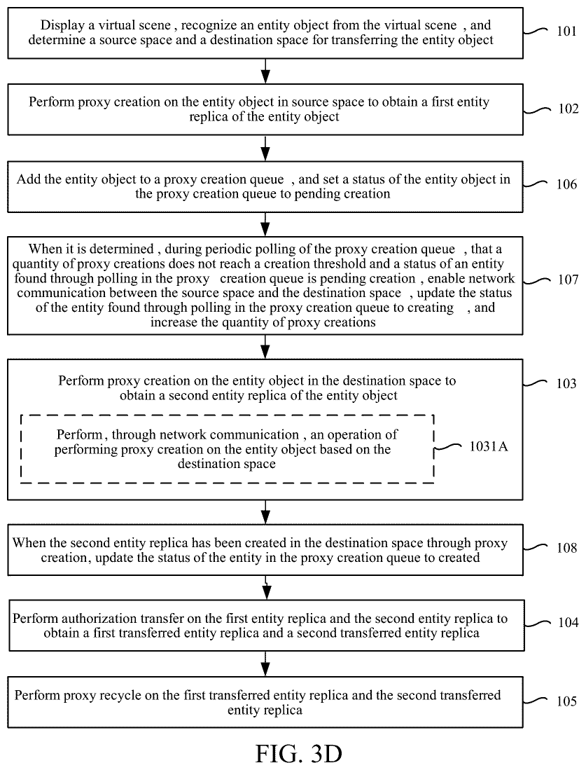

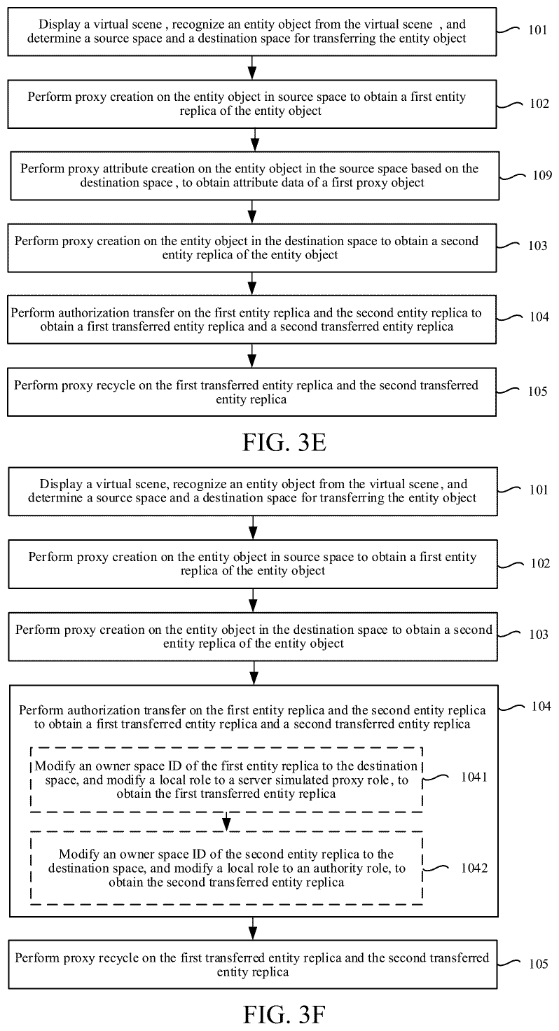

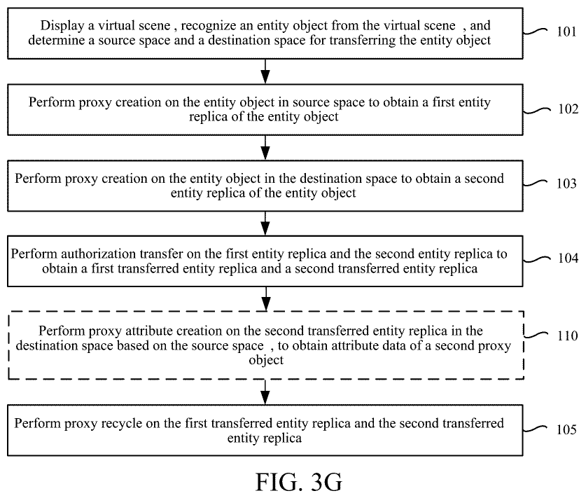

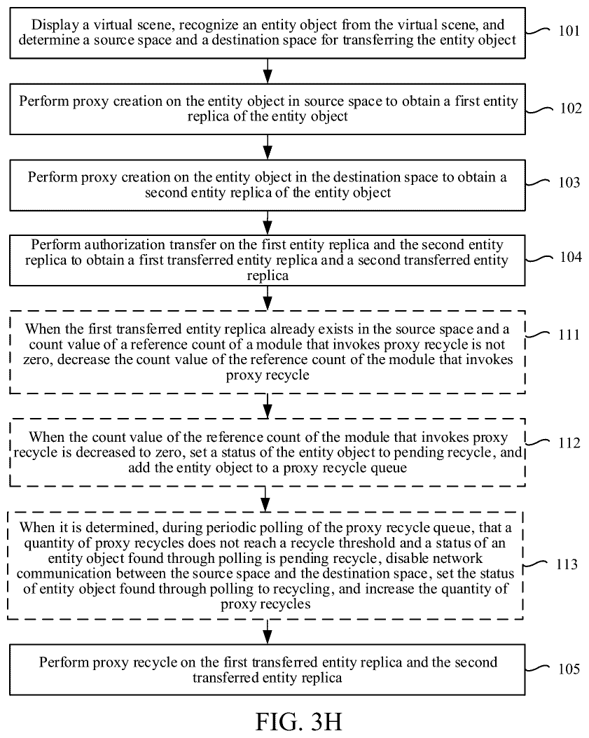

As described above, the data processing method for a virtual scene provided in the examples of this application may be implemented by various types of electronic devices, for example, a terminal, a server, or a combination thereof. Therefore, an entity for performing each operation is not repeatedly described below. FIG. 3A is a schematic flowchart of a data processing method for a virtual scene according to an example of this application. The method is described with reference to operations shown in FIG. 3A.

Before operation 101 is described, the data processing method for a virtual scene (including entity object transfer) is described. Without awareness of a user, from a logical perspective, entity object transfer is to transfer an entity object from a source space to a destination space, for example, transfer an entity object from one space to another space. When one space corresponds to one physical node (an entity object device in a computer network, for example, a network device such as a server, a router, or a switch), entity object transfer at an underlying physical layer in the examples of this application is to seamlessly transfer, to another physical node, a computer resource that is allocated to any entity replica on any physical node.

In the following operations, provided that an entity object appears in a virtual scene, an entity replica has been generated for the entity object in at least one space, at least one entity replica is created for the entity object in the virtual scene, and behavior is interpreted by using a spatial location and an owner. An attribute of the entity replica includes a unique identifier (ID), a local space ID of the entity replica, an owner space ID of the entity replica, a local role (a role of the entity replica in the local space), and an owner role (a role of an owner of the entity replica). The unique ID and the space ID of the entity replica are combined to uniquely determine the entity replica. To be specific, an ID of the entity replica includes the unique ID and the space ID. The local space ID of the entity replica is configured for identifying a space in which the entity replica is located. The owner space ID of the entity replica is configured for identifying a space in which the owner of the entity replica is located. The local role includes an authority role (which can change its own behavior), a server simulated proxy role (which cannot change its own behavior). The owner role includes an authority role.

Operation 101: Display a virtual scene, recognize an entity object from the virtual scene, and determine a source space and a destination space for transferring the entity object.

The source space is a start area from which the entity object is transferred in the virtual scene. The destination space is a destination area to which the entity object is transferred in the virtual scene.

The virtual scene includes the entity object. A form of the virtual scene is not limited in this example of this application. For example, the virtual scene in this example of this application may be a virtuality and reality combined scene or a completely virtual scene. Correspondingly, a form of the entity object is not limited in this example of this application. For example, the entity object may be a virtual object displayed in the virtual scene, or the entity object may be a virtual object obtained by superposing a virtual element on an entity object in the real world, or may be a virtual object that is completely obtained through virtualization.

Operation 102: Perform proxy creation on the entity object in the source space to obtain a first entity replica of the entity object.

For example, after a proxy creation event is triggered, proxy creation is first performed on the entity object on a server on which the source space is located (referred to as the source space for short) to obtain the first entity replica of the entity object. The first entity replica is a local entity replica in the source space. The proxy creation in the source space means performing server local proxy creation in the source space, to be specific, performing server local proxy creation on the entity object in the source space, to obtain the first entity replica of the entity object.

A game application is used as an example. When an entity object in the game application moves from a source space to a destination space in a virtual scene and is at a specified distance from an area boundary between the source space and the destination space, a proxy creation event is triggered, and proxy creation is performed on the entity object on a server on which the source space is located to obtain a first entity replica of the entity object. The proxy creation means creating a proxy object for the entity object, and the created proxy object is configured for inheriting some or all of attributes or methods of the entity object.

FIG. 3B is a schematic flowchart of a data processing method for a virtual scene according to an example of this application. An attribute of the first entity replica includes a unique ID, a local space ID (configured for identifying a space in which the first entity replica is located), an owner space ID (configured for identifying a space in which an owner of the first entity replica is located), and a local role (a role of the first entity replica in the local space). When no entity replica corresponding to the entity object exists in the source space, as shown in FIG. 3B, operation 102 in FIG. 3A may be implemented by using the following operation 1021 and operation 1022. Operation 1021: Generate a first initial entity replica having the attribute in the source space. Operation 1022: Reset the unique ID of the first initial entity replica to an ID of the entity object, reset the local space ID to the source space, reset the owner space ID to the source space, and reset the local role to an authority role, to obtain the first entity replica. Behavior data of the entity object is synchronized with behavior data of an entity replica of the authority role.

The first initial entity replica is an initial entity replica (namely, an initialized entity replica) corresponding to an entity object, and an attribute of the initial entity replica is empty or a specified value.

In an example of operation 1022, the source space is a space 1. When the attribute of the first entity replica includes the unique ID, the local space ID, the owner space ID, and the local role, the first entity replica of the authority role is generated in the space 1, and attribute data of the first entity replica of the authority role is (localspace 1; ownerspace 1; localrole authority). To be specific, the attribute data of the first entity replica of the authority role is data obtained by assigning a value to the attribute of the first entity replica of the authority role. When the attribute of the first entity replica includes the unique ID, the local space ID, the owner space ID, the local role, and the owner role, the first entity replica of the authority role is generated in the space 1, and attribute data of the first entity replica of the authority role is (localspace 1; ownerspace 1; localrole authority; ownerrole authority). To be specific, the attribute data of the first entity replica of the authority role is data obtained by assigning a value to the attribute of the first entity replica of the authority role.

In an actual application scenario, in a proxy creation stage, the entity object is still located in the source space, and behavior of the entity object needs to be synchronized with behavior of an entity replica in the source space. In view of this, to conform to the actual application scenario, the first entity replica is identified as the authority role by using the unique ID, local space ID, owner space ID, and local role attributes. In addition, because behavior data of the entity object is synchronized with behavior data of an entity replica of the authority role, in the proxy creation stage, behavior data of a second entity replica may be synchronized with the behavior data of the first entity replica. In other words, behavior of the second entity replica is synchronized with behavior of the first entity replica. In this way, the entity object is flexibly and quickly controlled through simple attribute settings.

In some examples, an underlying system maintains an entity replica by using a reference count, and pushes forward a subsequent process by using the entity replica and the reference count carried in the entity replica. The reference count includes an ID of a module that runs the virtual scene and a count value of the module for the entity object. Therefore, after operation 102, when the first entity replica already exists in the source space and a count value of a reference count of a module that invokes proxy creation (also referred to as a proxy creation event) is zero, the count value of the reference count of the module that invokes proxy creation is increased. The reference count represents a progress of the proxy creation. For example, the count value of the reference count of the module that invokes proxy creation is increased from 0 to 1. In other words, the reference count is added to the module that invokes proxy creation. When the count value of the reference count of the module that invokes proxy creation is 0, the proxy creation has not been completed. When the count value of the reference count of the module that invokes proxy creation is 1, the proxy creation is completed, and a subsequent process (for example, authorization transfer or proxy recycle) may be further pushed forward based on the count value of the reference count of the module that invokes proxy creation.

The module that invokes proxy creation may be a module for running the virtual scene in a background system, for example, a scene module (a module configured to manage the virtual scene and map information) or a view module (a module configured to control a field of view in the virtual scene).

Operation 103: Perform proxy creation on the entity object in the destination space to obtain a second entity replica of the entity object, and synchronize behavior data of the second entity replica with behavior data of the first entity replica.

For example, after the proxy creation event is triggered, proxy creation may be further performed on the entity object on a server on which the destination space is located (referred to as the destination space for short) to obtain the second entity replica of the entity object. The second entity replica is a local entity replica in the destination space. The proxy creation in the destination space means performing server local proxy creation in the destination space, to be specific, performing server local proxy creation on the entity object in the destination space, to obtain the second entity replica. The behavior data of the second entity replica is synchronized with the behavior data of the first entity replica. In other words, behavior of the second entity replica is the same as behavior of the first entity replica.

A game application is used as an example. When an entity object in the game application moves from a source space to a destination space in a virtual scene and is at a specified distance from an area boundary between the source space and the destination space, a proxy creation event is triggered, and proxy creation is performed on the entity object on a server on which the destination space is located to obtain a second entity replica of the entity object.

FIG. 3C is a schematic flowchart of a data processing method for a virtual scene according to an example of this application. An attribute of the second entity replica includes a unique ID, a local space ID, an owner space ID, and a local role. When no entity replica corresponding to the entity object exists in the destination space, as shown in FIG. 3C, operation 103 in FIG. 3A may be implemented by using the following operation 1031 and operation 1032. Operation 1031: Generate a second initial entity replica having the attribute in the destination space. Operation 1032: Reset the unique ID of the second initial entity replica to the ID of the entity object, reset the local space ID to the destination space, reset the owner space ID to the source space, and reset the local role to a server simulated proxy role, to obtain the second entity replica. Behavior data of an entity replica of the server simulated proxy role is synchronized with behavior data of an entity replica of the authority role.

The second initial entity replica is an initial entity replica corresponding to an entity object, and an attribute of the initial entity replica is empty or a specified value.

In an actual application scenario, in a proxy creation stage, the entity object is still located in the source space, and behavior of the entity object needs to be synchronized with behavior of an entity replica in the source space herein. In view of this, to conform to the actual application scenario, the second entity replica is identified as the server simulated proxy role by using the unique ID, local space ID, owner space ID, and local role attributes. In addition, because behavior data of an entity replica of the server simulated proxy role is synchronized with behavior data of an entity replica of the authority role, in the proxy creation stage, the behavior data of the second entity replica may be synchronized with the behavior data of the first entity replica. In other words, behavior of the second entity replica is synchronized with behavior of the first entity replica. In this way, the entity object is flexibly and quickly controlled through simple attribute settings.

In an example of operation 1032, the source space is a space 1, and the destination space is a space 2. When the attribute of the second entity replica includes a unique ID, a local space ID, an owner space ID, and a local role, the second entity replica of the server simulated proxy role is generated in the space 2, and attribute data of the second entity replica of the server simulated proxy role is (localspace 2; ownerspace 1; localrole server simulated proxy). To be specific, the attribute data of the second entity replica of the server simulated proxy role is data obtained by assigning a value to the attribute of the second entity replica of the server simulated proxy role. When the attribute of the second entity replica includes a unique ID, a local space ID, an owner space ID, a local role, and an owner role, the second entity replica of the server simulated proxy role is generated in the space 2, and attribute data of the second entity replica of the server simulated proxy role is (localspace 2; ownerspace 1; localrole server simulated proxy; ownerrole authority). To be specific, the attribute data of the second entity replica of the server simulated proxy role is data obtained by assigning a value to the attribute of the second entity replica of the server simulated proxy role.

FIG. 3D is a schematic flowchart of a data processing method for a virtual scene according to an example of this application. As shown in FIG. 3D, operation 106 to operation 108 are further included after operation 102, and operation 103 may be implemented by using operation 1031A. Operation 106: Add the entity object to a proxy creation queue, and set a status of the entity object in the proxy creation queue to pending creation. Operation 107: When it is determined, during periodic polling of the proxy creation queue, that a quantity of proxy creations does not reach a creation threshold and a status of an entity object found through polling in the proxy creation queue is pending creation, enable network communication between the source space and the destination space, update the status of the entity object found through polling in the proxy creation queue to creating, and increase the quantity of proxy creations. Operation 1031A: Perform, through network communication, an operation of performing proxy creation on the entity object based on the destination space. Operation 108: When the second entity replica has been created in the destination space through proxy creation, update the status of the entity object in the proxy creation queue to created.

The quantity of proxy creations is configured for indicating a quantity of times of performing server simulated proxy creation in the destination space.

The entity object (which may be an entity object ID) added to the proxy creation queue in operation 106 is configured for indicating to create an entity replica corresponding to the entity object in the destination space. To be specific, if the entity object is added to the proxy creation queue, an entity replica corresponding to the entity object needs to be created in the destination space. In operation 106, the entity object is added to the proxy creation queue, and periodic polling is performed on the proxy creation queue to smooth a proxy creation event and avoid a pressure surge on the server.

After the proxy creation event is triggered and an entity replica is created in the source space, a status of the entity object is set to pending creation in operation 106, so that a process is pushed forward based on the status of the entity object during subsequent polling of the proxy creation queue.

FIG. 3E is a schematic flowchart of a data processing method for a virtual scene according to an example of this application. As shown in FIG. 3E, operation 109 is further included before operation 104 in FIG. 3A. Operation 109: Perform proxy attribute creation on the entity object in the source space based on the destination space, to obtain attribute data of a first proxy object. The second entity replica is a first proxy object of the first entity replica, and the attribute data is configured for locating a space in which the first proxy object of the first entity replica is located.

In an example of operation 109, after the proxy creation event is triggered, proxy attribute creation may be further performed on the entity object on the server on which the source space is located (referred to as the source space for short) based on the destination space, to obtain the attribute data of the first proxy object. The proxy attribute creation based on the destination space means performing server local proxy creation on attribute data of a proxy object in the source space, in other words, creating the attribute data of the first proxy object in the source space. The attribute data of the first proxy object is the same as attribute data of the second entity replica. For example, the source space is a space 1, and the destination space is a space 2. When the attribute data of the second entity replica is (localspace 2; ownerspace 1; localrole server simulated proxy), the attribute data (localspace 2; ownerspace 1; localrole server simulated proxy) of the first proxy object is generated in the space 1.

The attribute data of the first proxy object is the attribute data of the second entity replica and is attribute data of an entity replica of the server simulated proxy role. The attribute data of the entity replica of the server simulated proxy role is retained in the source space, so that a space of an entity replica of a proxy role (namely, the server simulated proxy role) for an entity replica of the authority role can be located based on the attribute data of the entity replica of the server simulated proxy role.

In some examples, the attribute data includes a unique ID, a local space ID, an owner space ID, and a local role. Operation 109 may be implemented in the following manner: generating initial attribute data in the source space; and resetting the unique ID included in the initial attribute data to the ID of the entity object, resetting the local space ID to the destination space, resetting the owner space ID to the source space, and resetting the local role to the server simulated proxy role, to obtain the attribute data of the first proxy object. The initial attribute data is empty or a specified value.

Operation 104: Perform authorization transfer on the first entity replica and the second entity replica to obtain a first transferred entity replica and a second transferred entity replica.

The first transferred entity replica is obtained by performing authorization transfer on the first entity replica. The second transferred entity replica is obtained by performing authorization transfer on the second entity replica. The authorization transfer is to transfer or exchange a behavior control right of the first entity replica and a behavior control right of the second entity replica. When an entity replica has a behavior control right, behavior data of the entity replica is synchronized to behavior data of another entity replica. In other words, behavior of the another entity replica is the same as behavior of the entity replica.

A game application is used as an example. When an entity object in the game application moves to an area boundary between a source space and a destination space, an authorization transfer event is triggered, authorization transfer is performed on a first entity replica on a server on which the source space is located to obtain a first transferred entity replica, and authorization transfer is performed on a second entity replica on a server on which the destination space is located to obtain a second transferred entity replica.

FIG. 3F is a schematic flowchart of a data processing method for a virtual scene according to an example of this application. An attribute of the first entity replica and an attribute of the second entity replica both include an owner space ID and a local role. As shown in FIG. 3F, operation 104 in FIG. 3A may be implemented by using operations 1041 and 1042. Operation 1041: Modify the owner space ID of the first entity replica to the destination space, and modify the local role to the server simulated proxy role, to obtain the first transferred entity replica. Operation 1042: Modify the owner space ID of the second entity replica to the destination space, and modify the local role to the authority role, to obtain the second transferred entity replica.

In an example of operation 1041, related attributes of an entity replica (namely, the first entity replica) whose local space ID is the source space are modified: An owner space ID of the entity object is modified to a destination space ID, and a local role is modified to the server simulated proxy role. For example, the source space is a space 1, the destination space is a space 2, and in the proxy creation stage, two pieces of entity replica data are retained in the source space: entity replica data of the authority role (attribute data: (localspace 1; ownerspace 1; localrole authority; ownerrole authority)) and entity replica data of the server simulated proxy role (attribute data: (localspace 2; ownerspace 1; localrole server simulated proxy role; ownerrole authority)). After transfer is performed, related attributes of the entity replica whose local space ID is the source space are modified to obtain an entity replica (localspace 1; ownerspace 2; localrole server simulated proxy; ownerrole authority).

In an example of operation 1042, related attributes of an entity replica (namely, the second entity replica) whose local space ID is the destination space are modified: An owner space ID of the entity object is modified to a destination space ID, and a local role is modified to the authority role. For example, the source space is a space 1, the destination space is a space 2, and in the proxy creation stage, entity replica data of the server simulated proxy role and an entity replica of the server simulated proxy role (attribute data: (localspace 2; ownerspace 1; localrole server simulated proxy role; ownerrole authority)) are generated in the destination space. After transfer is performed, related attributes of the entity replica whose local space ID is the destination space are modified to obtain an entity replica (localspace 2; ownerspace 2; localrole authority role; ownerrole authority).

In some examples, before operation 104, when the entity object meets a queue processing condition, the entity object is added to a transfer queue; and when it is determined, during periodic polling of the transfer queue, that a quantity of transfers does not reach a transfer threshold and a latest destination space of the entity object is the same as the destination space, operation 104 is performed. The queue processing condition includes that the entity object is not a client-controlled entity object and the entity object is not processed in the transfer queue. The entity object (which may be an entity object ID) added to the transfer queue is configured for indicating to perform authorization transfer on the first entity replica and the second entity replica. The entity object is added to the transfer queue, and periodic polling is performed on the transfer queue to smooth an authorization transfer event and avoid a pressure surge on the server. Destination space redirection (to be specific, determining whether the latest destination space of the entity object is the same as the destination space) ensures accuracy of the destination space, and therefore improves accuracy of entity object transfer. The quantity of transfers is configured for indicating a quantity of times of performing authorization transfer in the destination space.

The entity object in the virtual scene may be of various types, for example, a client-controlled entity object (to be specific, an entity object that can be autonomously controlled by a user in the virtual scene, for example, a hero that can be currently controlled by the user), or a non-client-controlled entity object (to be specific, an entity object that cannot be autonomously controlled by a user in the virtual scene, for example, a non-player character (NPC)). The client-controlled entity object is a subset of the entity object, and an authorization transfer mode for the client-controlled entity object is based on an authorization transfer capability of the entity object.

FIG. 3G is a schematic flowchart of a data processing method for a virtual scene according to an example of this application. As shown in FIG. 3G, operation 110 is further included before operation 105 in FIG. 3A. Operation 110: Perform proxy attribute creation on the second transferred entity replica in the destination space based on the source space, to obtain attribute data of a second proxy object. The first transferred entity replica is a second proxy object of the second transferred entity replica, and the attribute data is configured for locating a space in which the second proxy object of the second transferred entity replica is located.

The second proxy object of the second transferred entity replica is created in the destination space, so that a space of an entity replica of a proxy role (namely, the server simulated proxy role) for an entity replica (namely, the first transferred entity replica) of the authority role can be quickly located based on the attribute data of the second proxy object of the second transferred entity replica, to find the space in which the entity replica of the server simulated proxy role is located.

In an example of operation 110, after an authorization transfer event is triggered, proxy attribute creation may be further performed on the second transferred entity replica on the server on which the destination space is located (referred to as the destination space for short) based on the source space, to obtain the attribute data of the second proxy object. The proxy attribute creation based on the source space means performing server local proxy creation on attribute data of a proxy object in the destination space, in other words, creating the attribute data of the second proxy object in the destination space. The attribute data of the second proxy object is the same as attribute data of the first transferred entity replica. For example, the source space is a space 1, and the destination space is a space 2. When the attribute of the second entity replica includes a unique ID, a local space ID, an owner space ID, and a local role, and the attribute data of the second entity replica is (localspace 1; ownerspace 2; localrole server simulated proxy), the attribute data (localspace 1; ownerspace 2; localrole server simulated proxy) of the second proxy object is generated in the space 2.

In some examples, the attribute data includes a unique ID, a local space ID, an owner space ID, and a local role. Operation 110 may be implemented in the following manner: generating initial attribute data in the destination space; and resetting the unique ID included in the initial attribute data to the ID of the entity object, resetting the local space ID to the source space, resetting the owner space ID to the destination space, and resetting the local role to the server simulated proxy role, to obtain the attribute data of the second proxy object. The initial attribute data is empty or a specified value.

In some examples, when the entity object is a client-controlled entity object, before operation 104, a network connection is created, through a gateway, between the gateway and the server on which the destination space is located. After operation 104, a transfer start message is transmitted, through the gateway, to the client that controls the entity object, the transfer start message carrying a connection relationship of the network connection, and the transfer start message being configured for indicating the client to switch a proxy authorization connection to the network connection; a switching message transmitted by the client is received through the gateway, the switching message indicating that the client has switched the proxy authorization connection to the network connection; and an authorization transfer success message is transmitted, through the gateway, to the server on which the destination space is located, the authorization transfer success message being configured for indicating the server on which the destination space is located to bind the client-controlled entity object to the network connection, to enable network communication between the client, the gateway, and the server on which the destination space is located. In this way, the gateway is introduced to hide, in the background, an operation of switching the client-controlled entity object between different spaces, so that a user is unaware of authorization transfer.

Operation 105: Perform proxy recycle on the first transferred entity replica and the second transferred entity replica.

In the computer field, proxy recycle is to recycle and release a proxy entity replica. This operation is usually performed to release resources or reduce memory consumption when an entity replica is no longer needed.

For example, after a proxy recycle event is triggered, proxy recycle is performed on the first transferred entity replica and the second transferred entity replica to restore to an initial state. A game application is used as an example. When an entity object in the game application moves to a destination space and is at a specified distance from an area boundary between a source space and the destination space, a proxy recycle event is triggered, proxy recycle is performed on a first transferred entity replica on a server on which the source space is located, and proxy recycle is performed on a second transferred entity replica on a server on which the destination space is located.

FIG. 3H is a schematic flowchart of a data processing method for a virtual scene according to an example of this application. As shown in FIG. 3H, operations 111 to 113 are further included before operation 105. Operation 111: When the first transferred entity replica already exists in the source space and a count value of a reference count of a module that invokes proxy recycle is not zero, decrease the count value of the reference count of the module that invokes proxy recycle (a proxy recycle event). Operation 112: When the count value of the reference count of the module that invokes proxy recycle is decreased to zero, set a status of the entity object to pending recycle, and add the entity object to a proxy recycle queue. Operation 113: When it is determined, during periodic polling of the proxy recycle queue, that a quantity of proxy recycles does not reach a recycle threshold and a status of an entity object found through polling is pending recycle, disable network communication between the source space and the destination space, set the status of entity object found through polling to recycling, and increase the quantity of proxy recycles. The quantity of proxy recycles is configured for indicating a quantity of times of performing proxy recycle.

The entity object (which may be an entity object ID) added to the proxy recycle queue in operation 112 is configured for indicating to perform proxy recycle on an entity replica. To be specific, if the entity object is added to the proxy recycle queue, created entity replicas need to be recycled in the destination space and the source space. In operation 112, the entity object is added to the proxy recycle queue, and periodic polling is performed on the proxy recycle queue to smooth a proxy recycle event and avoid a pressure surge on the server.

The proxy recycle event is triggered, and the status of the entity object is reset to pending recycle in operation 106, so that a process is pushed forward based on the status of the entity object during subsequent polling of the proxy recycle queue.

In some examples, an underlying system maintains an entity replica by using a reference count, and pushes forward a subsequent process by using the entity replica and the reference count carried in the entity replica. The reference count includes a module ID and a count value of the module for the entity object. Therefore, after operation 102, when the first transferred entity replica already exists in the source space and a count value of a reference count of a module that invokes proxy recycle is not zero, the count value of the reference count of the module that invokes proxy recycle is decreased. For example, the count value of the reference count of the module that invokes proxy recycle is decreased from 1 to 0. In other words, the reference count of the module that invokes proxy recycle is decreased.

The following describes applications of the examples of this application.

The examples of this application may be applied to related applications such as metaverse applications and open big world games, including, for example, project and product applications such as a virtual world, a large-scale virtual simulation system, and a virtual game, and can provide the related applications with a high-quality and stable function of transferring entity object data, to improve computing parallelism and a bearing capability of a server system, and improve user experience for a client.

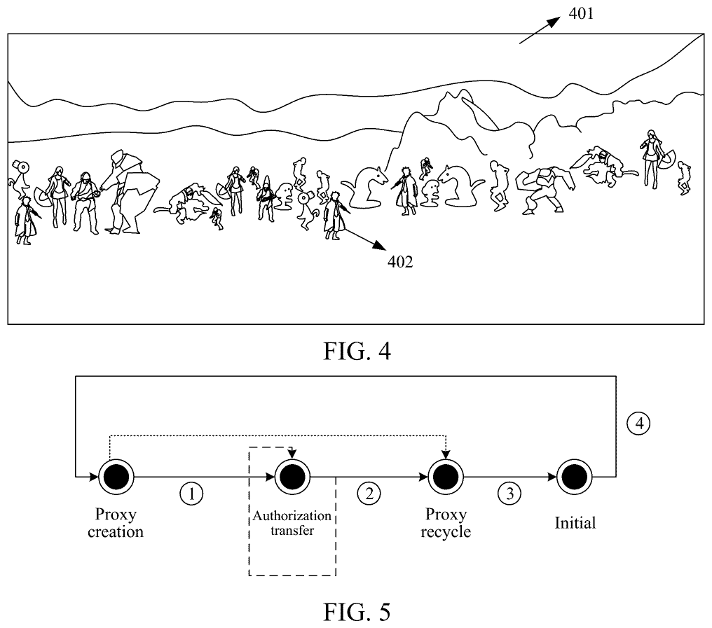

In a metaverse virtual world 401 shown in FIG. 4, in the examples of this application, a unique ID may be determined in the metaverse for an entity object (a virtual object) such as a role, a character 402, or a building in the virtual world 401, and data of the entity object is distributed, so that the virtual world is not limited by a bottleneck of computing resources on a single computer. A space for describing the virtual world is expanded based on an infinite capacity expansion capability of computer resources, so that massive entity replicas can be carried in the expanded space of the virtual world, and interaction can be performed in the virtual world.

In addition, in this application scenario of the metaverse virtual world, in the examples of this application, an entity object may be transferred from a source space to a destination space without awareness of a user. For example, an entity object is transferred from one space to another space. When one space corresponds to one physical node (e.g., an entity object device in a computer network, for example, a network device such as a server, a router, or a switch), entity object transfer at an underlying physical layer in the examples of this application is to seamlessly transfer, to another physical node, a computer resource that is allocated to any entity replica on any physical node. In addition, fault detection is performed on possible issues such as hardware faults and network fluctuation during the transfer, to restore a running state. This fully improves timeliness and robustness of a large-scale distributed system such as the metaverse virtual world.

In the related art, in a game application in which a seamless big world is applied, full data of a real role is transmitted to a server on which a ghost role is located, and switching between the real role and the ghost role is performed on the server to transfer an entity object. However, this solution of transferring an entity object by packaging full data is prone to various errors, and cannot ensure effectiveness of entity object transfer.

To solve the foregoing problem, this application provides a data processing method for a virtual scene, to meet a control requirement for an entity replica from an underlying technological layer. Entity object transfer is divided into a plurality of stages, to smooth an entire transfer process. When a problem occurs during the transfer process, compared with the related art in which the program cannot accurately located in a timely manner, in this application, the problem can be located in a timely manner, to achieve high timeliness of the transfer. When a problem occurs during the transfer process, in the examples of this application, the problem can be resolved in a timely manner through rollback or by pushing forward the process, to achieve effectiveness of the transfer. Distributed entity object data (namely, entity replicas) is recorded at an underlying layer of a system. Therefore, when a problem occurs in each stage of entity object transfer, a system operating status can be effectively determined based on the entity object data, to avoid a chaos phenomenon.

Before the data processing method for a virtual scene provided in the examples of this application is described, a modeling solution for an entity replica is first described.

For a metaverse application of a distributed seamless big world, space and time seem continuous and sustainable to a player. However, due to a bottleneck of computing resources on a single computer, a distributed seamless big world solution is introduced, with a final objective to describe space based on an infinite capacity expansion capability of computer resources and describe time based on an infinite capacity expansion capability of storage resources.

In addition, due to a bottleneck of a single computer, to describe continuity of space, a server is introduced to manage a space boundary and an overlapping area managed by the server, to achieve space continuity and seamless player experience.

To achieve the foregoing objective, in the examples of this application, existence of an entity replica in a plurality of spaces in a metaverse application and a control right of the entity replica are described, to model the entity replica. The modeling is described and restricted as follows:
1. One entity object may have entity replicas in a plurality of spaces, and each space includes an entity replica corresponding to only one entity object.
2. An entity replica is able to be manipulated by an owner of the entity replica.
3. A special entity replica exists in the metaverse, and the special entity replica is able to manipulate behavior of other entity replicas in a plurality of spaces.

In addition, the entity replica described above represents a mapping set of an entity object in the metaverse. Provided that an entity object appears in the metaverse, an entity replica has been generated for the entity object in at least one space, at least one entity replica is created for the entity object in the metaverse, and behavior is interpreted by using a spatial location and an owner. Attributes of an entity replica are shown in Table 1.

TABLE 1
Entity replica modeling table

| Attribute name | Description |
|---|---|
| Unique ID of the | The unique ID of the entity replica is configured for |
| entity replica | identifying an entity object. The unique ID of the entity |
| | replica and a space ID are combined to uniquely |
| | determine the entity replica. To be specific, an ID of the |
| | entity replica includes the unique ID and the space ID. |
| | For example, a plurality of spaces in the metaverse each |
| | include an entity replica of Iron Man, a unique ID of the |
| | entity replica is configured for identifying Iron Man, and |
| | a space ID is configured for identifying a spatial location |
| | of the entity replica of Iron Man. |
| Local space ID of | The local space ID of the entity replica is configured for |
| the entity replica | identifying a space in which the entity replica is located. |
| Owner space ID of | The owner space ID of the entity replica is configured for |
| the entity replica | identifying a space in which an owner of the entity replica |
| | is located |
| Local role (a role | Based on a self-behavior change capability of the entity |
| of the entity replica | replica, the space in which the entity replica is located, |
| in the local space) | and a relationship between the space in which the entity |
| | replica is located and the owner space, the local role |
| | includes an authority role (which can change its own |
| | behavior) and a server simulated proxy role (which |
| | cannot change its own behavior). |
| Owner role (a role | The owner role includes an authority role. |
| of an owner of the | |
| entity replica) | |

The following describes an entity object transfer process in the examples of this application with reference to a state machine.

In a metaverse application, to provide a user with better experience and make the user unaware of a data transfer process in a metaverse world, a technical solution with high timeliness and effectiveness is needed for implementing entity object transfer. In view of this requirement, in the examples of this application, overall entity object transfer is divided into three stages (a proxy creation stage, an authorization transfer stage, and a proxy recycle stage), and a corresponding state table during an entity object transfer process is summarized. The entity object transfer state table is shown in Table 2.

TABLE 2
Entity object transfer state table

| State | Name | Description |
|---|---|---|
| Proxy creation (also referred to as | ProxyCreate | The entity object is in a stage of |
| server simulated proxy creation, which | | creating an entity replica from a |
| is configured for creating an entity | | source space to the destination |
| replica (a proxy object) and setting a | | space. |
| role of an entity replica in a destination | | |
| space to a server simulated proxy role) | | |
| Authorization transfer | Authority | The entity object is in a stage of |
| | Transfer | performing authorization transfer |
| | | from the source space to the |
| | | destination space. |
| Proxy recycle (also referred to as server | ProxyRemove | The entity object is in a stage of |
| simulated proxy recycle, which is | | recycling an entity replica from the |
| configured for deleting an entity replica | | destination space to the source |
| whose role is the server simulated proxy | | space. |
| role) | | |
| Initial | Init | The entity object is in an initial |
| | | state. |

As shown in the foregoing table, in the examples of this application, the entity object transfer process is systematically divided into three stages (proxy creation, authorization transfer, and proxy recycle), and each stage corresponds to a start state and an end state. In this way, each stage can be independently run, and when the system has a problem, a status of the entity object transfer can be located in a timely manner to determine whether to roll back or push forward the process, so that technical reliability of the entity object data transfer process is greatly improved.

In the examples of this application, a status of each stage may be defined by using an entity replica. Locating the status of the entity object transfer to determine whether to roll back or push forward the process is described below by using an example.

In the initial state, no data exists, and a problem occurring in any space in the system is irrelevant to the entity object transfer. After the proxy creation is completed, the source space and the destination space include data of entity replicas.

There are the following cases about the rollback: When a downtime exception occurs in the source space, a character may be offline (lost), in other words, an entity replica in the source space is lost. Consequently, an entity replica in the destination space is also offline. After the source space is restored (to be specific, a server on which the source space is located is restarted), the entity replicas in the source space and the destination space are cleared, and the entity object is rolled back to the initial state. When a downtime exception occurs in the destination space, an entity replica in the destination space is offline (lost), and the source space is indicated to delete an entity replica corresponding to the destination space, to roll back to a state (namely, the initial state) before the entity object initiates proxy creation to the destination space. During an authorization transfer process, after role switching in the source space is completed, when a downtime exception occurs in the destination space during the authorization transfer, a local role of an entity replica in the source space is a server simulated proxy role. When a specified timeout period elapses or a notification indicating that a problem occurs in the destination space is obtained, the entity replica in the source space is rolled back to a state before the transfer, to be specific, a state before the entity authorization transfer.

There are the following cases about the push-forward: In the initial state, entity replicas are empty, and the process may be pushed forward to the proxy creation state. When the proxy creation state is completed, the source space and the destination space have data of entity replicas in the source space, and the process may be pushed forward to the authorization transfer state. When the authorization transfer state is completed, the source space and the destination space have data of entity replicas in the source space, and the process may be pushed forward to the proxy recycle state. After the proxy recycle state is completed, the data of the entity replicas in the source space and the destination space is recycled, and the process returns to the initial state.

As shown in FIG. 5, in a normal case, entity object transfer is cyclically switched in states 1->2->3->4, and a strong dependency exists between state nodes in sequence. In a special case, as shown in FIG. 5, the process may directly switch from the proxy creation state to the proxy recycle state. For example, in a user roaming stage (the user has no task), the process may return from the proxy creation state to the initial state through a proxy recycle node. After role switching is performed through an authorization transfer node, role switching is performed again. In this case, the authorization transfer node needs to be converted again. To be specific, a state change of authorization transfer is performed within the node.

The three stages (proxy creation, authorization transfer, and proxy recycle) shown in FIG. 5 may all be triggered by a module in a virtual scene. For example, a user controls an entity object to roam and walk in a metaverse application, and an event corresponding to any stage corresponding to entity object transfer may be triggered based on a trigger of a scene module (a module configured to manage a virtual scene and map information) in combination with an entity replica. For example, the metaverse includes two spatial areas (for example, a source space and a destination space), an area boundary exists between the two spatial areas, a trigger 1 is set in the source space at a specified distance from the area boundary, a trigger 2 is set at the area boundary, and a trigger 3 is set in the destination space at a specified distance from the area boundary. In a process in which the entity object roams and walks from the source space to the destination space in the metaverse application, the entity object first reaches a specified distance from the area boundary in the source space (this indicates that the entity object is about to reach the destination space), and the trigger 1 is triggered. In this case, a proxy creation event is triggered, to create an entity replica of a server simulated proxy role in the destination space. Then, when the entity object roams to the area boundary, the trigger 2 is triggered. In this case, an entity object transfer event is triggered, to switch roles of entity replicas in the destination space and the source space. Finally, the entity object roams to a specified distance from the area boundary in the destination space (this indicates that the entity object is away from the source space), and the trigger 3 is triggered. In this case, a proxy recycle event is triggered, to recycle the entity replicas in the destination space and the source space.

The following separately describes the three stages, that is, proxy creation, authorization transfer, and proxy recycle, shown in FIG. 5.

### (1) Proxy Creation During Entity Object Transfer

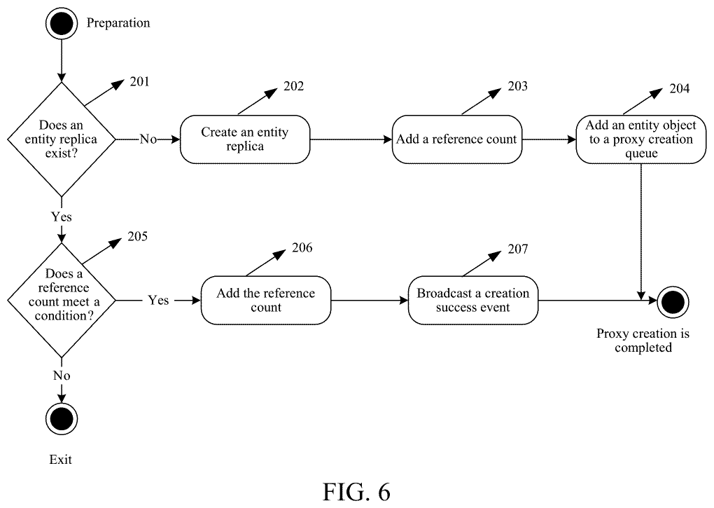

FIG. 6 is a schematic flowchart of a proxy creation event according to an example of this application. Descriptions are provided below with reference to operations shown in FIG. 6. The proxy creation event supports initiation by a plurality of modules in a metaverse, for example, a view module (a module configured to control a field of view in a virtual scene) and a scene module.

Operation 201: Determine whether an entity replica corresponding to an entity object exists. When no entity replica corresponding to the entity object exists, operation 202 is performed. When an entity replica corresponding to the entity object exists, operation 205 is performed.

Operation 202: Create an entity replica in a source space.

When the entity object stays in the source space, if the entity object is not associated with another space, no entity replica is generated in the source space. Therefore, when a proxy creation event is triggered, an entity replica needs to be created in the source space.

For example, a unique ID of an entity replica, a source space ID, and a destination space ID are obtained, and an entity replica of an authority role is created in the source space. An ID of the entity replica of the authority role is (a unique ID of the entity replica+a source space ID), a local space ID is the source space ID, an owner space ID is the source space ID, a local role is the authority role, and an owner role is the authority role.

In some examples, attribute data of an entity replica of a server simulated proxy role is retained in the source space, so that a space of an entity replica of a proxy role (namely, the server simulated proxy role) for the entity replica of the authority role can be located based on the attribute data of the entity replica of the server simulated proxy role.

For example, the source space is a space 1, the destination space is a space 2, and attribute data of two entity replicas may be retained in the source space: attribute data of the entity replica of the authority role (localspace 1; ownerspace 1; localrole authority; ownerrole authority), and attribute data of the entity replica of the server simulated proxy role (localspace 2; ownerspace 1; localrole server simulated proxy role; ownerrole authority).

Operation 203: Add a reference count to a module that invokes the proxy creation event.

An underlying system maintains an entity replica by using a reference count, and pushes forward a subsequent process by using the entity replica and the reference count carried in the entity replica. The reference count includes a module ID and a count value of the module for the entity object, as shown in Table 3.

TABLE 3
Reference count

| Module ID | Count value |
|---|---|
| View module | 1 |
| Scene (geo) module | 1 |

For example, after the entity replica is created in the source space, the reference count is added to the module that invokes the proxy creation event, and a count value of the reference count is reset to 1.

Operation 204: Add the entity object to a proxy creation queue.

After the entity replica is created in the source space and the reference count is added to the module that invokes the proxy creation event, the entity object is added to the proxy creation queue. Then periodic polling needs to be performed on the proxy creation queue to retrieve a to-be-created proxy object in the proxy creation queue (namely, an entity object in the proxy creation queue, configured for indicating to create an entity replica in the destination space). Periodic polling is performed on the proxy creation queue to smooth the proxy creation event and avoid a pressure surge on a server.

After the proxy creation event is triggered and the entity replica is created in the source space, a status of the entity object is set to pending creation, and then the entity object is added to the proxy creation queue, so that a process is pushed forward based on the status of the entity object during subsequent polling of the proxy creation queue.

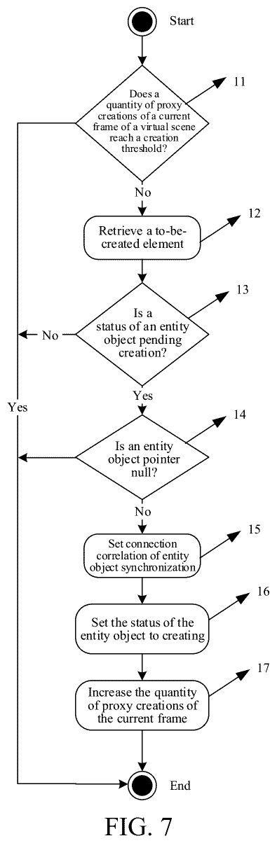

FIG. 7 is a schematic flowchart of polling of a proxy creation queue according to an example of this application. Descriptions are provided with reference to operations shown in FIG. 7.

Operation 11: Determine whether a quantity of proxy creations of a current frame of a virtual scene reaches a creation threshold. When the quantity of proxy creations of the current frame does not reach the creation threshold, operation 12 is performed. When the quantity of proxy creations of the current frame reaches the creation threshold, the process ends.

A frame is configured for indicating a time period, for example, current 15 milliseconds. The quantity of proxy creations is configured for indicating a quantity of times of performing server simulated proxy creation in a destination space.

Operation 12: Retrieve a to-be-created element from the proxy creation queue.

During each time of polling, when the quantity of proxy creations of the current frame does not reach the creation threshold, to-be-created elements (to be specific, IDs of entity objects in the proxy creation queue, configured for indicating to create an entity replica in the destination space) are sequentially retrieved from the proxy creation queue.

Operation 13: Determine whether a status of an entity object is pending creation. When the status of the entity object is pending creation, operation 14 is performed. When the status of the entity object is not pending creation, the process ends.

Operation 14: Determine whether an entity object pointer is null. When the entity object pointer is not null, operation 15 is performed. When the entity object pointer is null, the process ends.

The entity object pointer points to an entity replica of the entity object. When the entity object pointer is null, no entity replica exists in the destination space.

Whether proxy creation needs to be performed on an entity replica (to be specific, whether an entity replica of a server simulated proxy role is to be created in the destination space) is determined based on the status, the entity object pointer, and the like.

Operation 15: Set connection correlation of entity object synchronization.

The setting connection correlation of entity object synchronization is to enable a synchronization module to allow the entity object to perform network communication from a source space to the destination space.

Operation 16: Set the status of the entity object to creating.

Operation 17: Increase the quantity of proxy creations of the current frame.

After the quantity of proxy creations of the current frame is increased, proxy creation is initiated by a module configured for data synchronization (data communication). When data synchronization starts, the status of the entity object is updated to remote creating. After an entity replica is created in the destination space, it is considered that a proxy creation event of a module that invokes the proxy creation event is completed, the status of the entity object is set to created, an entity replica of a server simulated proxy role is generated in the destination space. An ID of the entity replica of the server simulated proxy role is (a unique ID of the entity replica+a destination space ID), a local space ID is the destination space ID, an owner space ID is a source space ID, a local role is the server simulated proxy role, and an owner role is an authority role.

Operation 205: Determine whether a reference count of a module that invokes a proxy creation event meets a condition. When the condition is met, operation 206 is performed. When the condition is not met, the process ends.

For example, when a count value of the reference count of the module that invokes the proxy creation event is 0, the reference count of the module that invokes the proxy creation event meets the condition.

Operation 206: Add the reference count to the module that invokes the proxy creation event.

Operation 207: Broadcast a proxy creation success event.

If the proxy creation success event is broadcast, it is considered that the proxy creation event of the module that invokes the proxy creation event is completed.

To sum up, after the proxy creation event is completed, entity replica data of an authority role and entity replica data of a server simulated proxy role are retained in the source space. To be specific, an ID of the entity replica data of the authority role is (a unique ID of the entity object+a source space ID), a local space ID of the entity object is the source space ID, an owner space ID of the entity object is the source space ID, a local role is the authority role, and an owner role is the authority role; and an ID of the entity replica data of the server simulated proxy role is (a unique ID of the entity object+a destination space ID), a local space ID of the entity object is the destination space ID, an owner space ID of the entity object is a source space ID, a local role is the server simulated proxy role, and an owner role is an authority role. Entity replica data of a server simulated proxy role is retained in the destination space. An ID of the entity replica data is (a unique ID of the entity object+a destination space ID), a local space ID of the entity object is the destination space ID, an owner space ID of the entity object is a source space ID, a local role is the server simulated proxy role, and an owner role is an authority role.

### (2) Authorization Transfer During Entity Object Transfer

An entity object in a metaverse application may be of various types, for example, a client-controlled entity object (for example, a hero that can be currently controlled by a user), or a non-client-controlled entity object (for example, an NPC). The client-controlled entity object is a subset of the entity object, and an authorization transfer mode for the client-controlled entity object is based on an authorization transfer capability of the entity object.

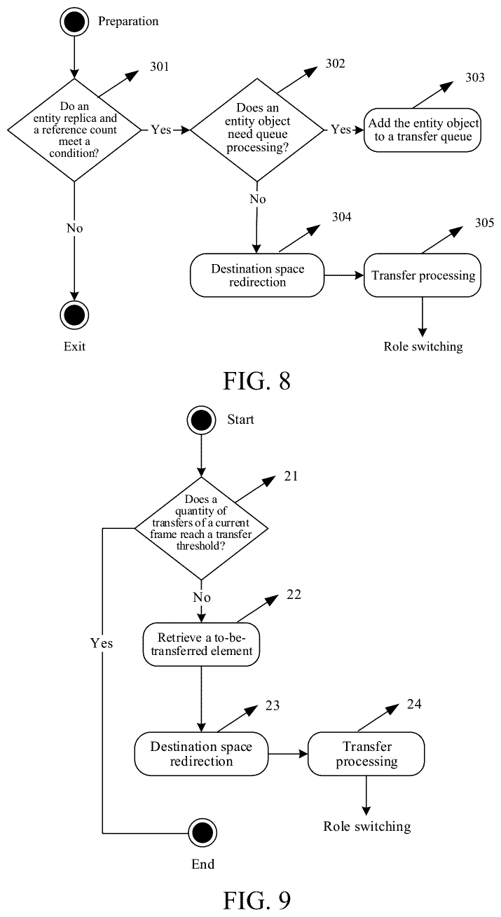

FIG. 8 is a schematic flowchart of an authorization transfer event according to an example of this application. Descriptions are provided with reference to operations shown in FIG. 8.

Operation 301: Determine whether an entity replica corresponding to an entity object and a reference count both meet a condition. When the condition is met, operation 302 is performed. When the condition is not met, the process ends.

After an authorization transfer event is triggered, when an entity replica on which authorization transfer is to be performed and that corresponds to the entity object is an authority role, and an entity replica exists in a destination space, the entity replica corresponding to the entity object meets the condition. When a count value of a reference count corresponding to a scene module that triggers the authorization transfer event is 1, the reference count meets the condition.

Operation 302: Determine whether the entity object needs queue processing. When queue processing is needed, operation 303 is performed. When no queue processing is needed, operation 304 is performed.

A client-controlled entity object has a preparation stage for creating a connection and has a queuing mode. Therefore, when the entity object is a client-controlled entity object, no queue processing is needed. When the entity object is an entity object already retrieved from a transfer queue, the entity object does not need queue processing either. When the entity object is a non-client-controlled entity object and has not undergone queue processing, the entity object needs queue processing.

Operation 303: Add the entity object to a transfer queue.

When the entity object needs queue processing, the entity object (to be specific, entity object information, for example, an ID of the entity object) is directly added to the transfer queue, to facilitate subsequent polling of the transfer queue.

FIG. 9 is a schematic flowchart of polling of a transfer queue according to an example of this application. Descriptions are provided with reference to operations shown in FIG. 9.

Operation 21: Determine whether a quantity of transfers of a current frame reaches a transfer threshold. When the transfer threshold is not reached, operation 22 is performed. When the transfer threshold is reached, the process ends.

A frame is configured for indicating a time period, for example, current 15 milliseconds. The quantity of transfers is configured for indicating a quantity of times of performing authorization transfer in a destination space.

Operation 22: Retrieve a to-be-transferred element from the transfer queue.

During each time of polling, when the quantity of transfers of the current frame does not reach the transfer threshold, to-be-transferred elements (to be specific, IDs of entity objects in the transfer queue, configured for indicating to perform authorization transfer on an entity replica) are sequentially retrieved from the transfer queue.

Operation 23: Perform destination space redirection on the entity object.

The destination space redirection is to recheck the destination space. For example, a latest destination space ID, found by a scene module, of the entity object is obtained. If the latest destination space ID is zero, no transfer needs to be performed, destination space redirection needs to be performed, and a redirected-to destination space is reset to a source space ID. If the latest destination space ID is the same as a source space ID of the entity object, no transfer needs to be performed, destination space redirection needs to be performed, and a redirected-to destination space is reset to the source space ID. If the latest destination space ID is different from a destination space ID that is set before the entity object is queued, destination space redirection needs to be performed, and a redirected-to destination space is reset to the latest destination space ID.

Operation 24: Perform transfer processing on the entity object.

Role switching occurs in the transfer processing operation. In this case, a local role of an entity replica whose local space ID is the source space is modified from an authority role to a server simulated proxy role, and the entity replica in the source space temporarily loses mobility.

The transfer processing process is as follows: Related attributes of an entity replica whose local space ID is the source space are modified: An owner space ID of the entity object is modified to the destination space ID, and a local role is modified to the server simulated proxy role. Attributes of an entity replica whose local space ID is the destination space are modified: An owner space ID of the entity object is modified to the destination space ID, and a local role is modified to the authority role. The entity replica whose local space ID is the destination space is deleted from the source space. Entity replica data of a server simulated proxy role is generated in the destination space. An ID of the entity replica data is (a unique ID of the entity object+a source space ID), a local space ID of the entity object is the source space ID, an owner space ID of the entity object is a destination space ID, a local role is the server simulated proxy role, and an owner role is an authority role.

For example, the source space is a space 1, the destination space is a space 2, and in a proxy creation stage, two pieces of entity replica data are retained in the source space: entity replica data of an authority role (attribute data: (localspace 1; ownerspace 1; localrole authority; ownerrole authority)) and entity replica data of a server simulated proxy role (attribute data: (localspace 2; ownerspace 1; localrole server simulated proxy; ownerrole authority)). Entity replica data of a server simulated proxy role and an entity replica of the server simulated proxy role (attribute data: (localspace 2; ownerspace 1; localrole server simulated proxy; ownerrole authority)) are generated in the destination space.

After transfer processing is performed, related attributes of the entity replica whose local space ID is the source space are modified to obtain an entity replica (localspace 1; ownerspace 2; localrole server simulated proxy; ownerrole authority). Related attributes of the entity replica whose local space ID is the destination space are modified to obtain an entity replica (localspace 2; ownerspace 2; localrole authority role; ownerrole authority). The entity replica whose local space ID is the destination space is deleted from the source space.

Operation 304: Perform destination space redirection on the entity object.

The destination space redirection is to recheck the destination space. For example, a latest destination space ID, found by a scene module, of the entity object is obtained. If the latest destination space ID is zero, no transfer needs to be performed, destination space redirection needs to be performed, and a redirected-to destination space is reset to a source space ID. If the latest destination space ID is the same as a source space ID of the entity object, no transfer needs to be performed, destination space redirection needs to be performed, and a redirected-to destination space is reset to the source space ID. If the latest destination space ID is different from a destination space ID that is set before the entity object is queued, destination space redirection needs to be performed, and a redirected-to destination space is reset to the latest destination space ID.

Operation 305: Perform transfer processing on the entity object.

Role switching occurs in the transfer processing operation. In this case, a local role of an entity replica whose local space ID is the source space is modified from an authority role to a server simulated proxy role, and the entity replica in the source space temporarily loses mobility.

To sum up, after the authorization transfer event is completed, only entity replica data of a server simulated proxy role is retained in the source space. An ID of the entity replica data is (a unique ID of the entity object+a source space ID), a local space ID of the entity object is the source space ID, an owner space ID of the entity object is a destination space ID, a local role is the server simulated proxy role, and an owner role is an authority role. Entity replica data of an authority role and entity replica data of a server simulated proxy role exist in the destination space. To be specific, an ID of the entity replica data of the authority role is (a unique ID of the entity object+a destination space ID), a local space ID of the entity object is the destination space ID, an owner space ID of the entity object is the destination space ID, a local role is the authority role, and an owner role is the authority role; and an ID of the entity replica data of the server simulated proxy role is (a unique ID of the entity object+a source space ID), a local space ID of the entity object is the source space ID, an owner space ID of the entity object is a destination space ID, a local role is the server simulated proxy role, and an owner role is an authority role.

In some examples, when an entity object on which authorization transfer needs to be performed is a client-controlled entity object, to make an entire entity object transfer process smoother and make a user unaware of the authorization transfer, a gateway is introduced to hide, in the background, an operation of switching the client-controlled entity object between different spaces. Connection switching is hidden to avoid freezing caused by network data transmission during switching of an entity object. This reduces unsmooth experience caused by network exceptions, and fully shortens time needed for authorization transfer of a client-controlled entity object.

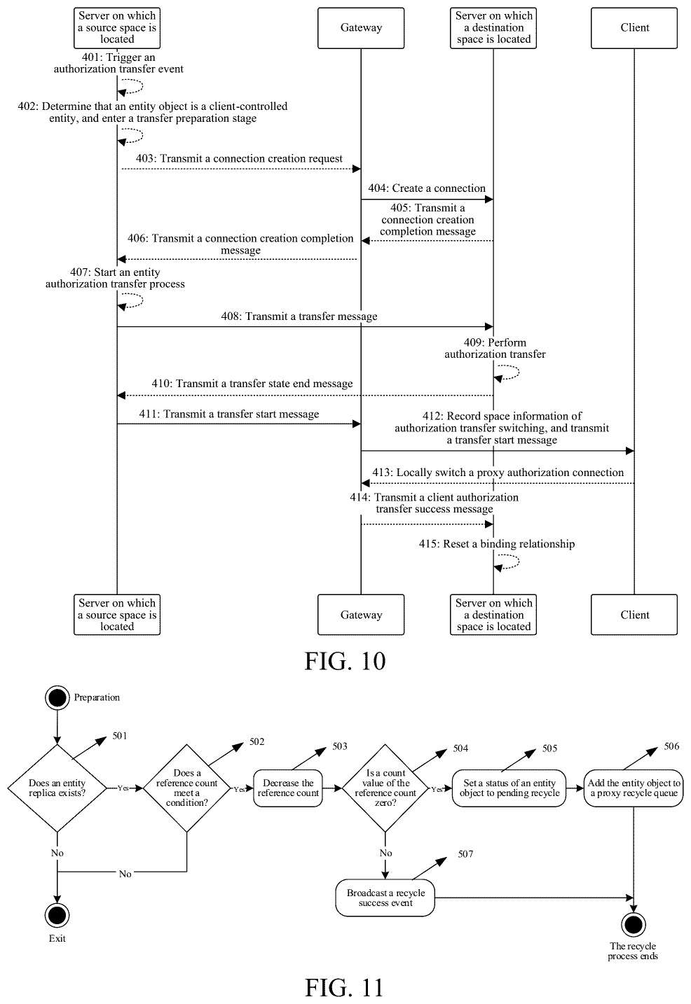

FIG. 10 is a diagram of a time sequence of authorization transfer of a client-controlled entity object according to an example of this application. Descriptions are provided with reference to operations shown in FIG. 10.

Operation 401: A server on which a source space is located triggers an authorization transfer event.

Operation 402: The server on which the source space is located enters an authorization transfer preparation stage when determining that an entity object is a client-controlled entity object.

Operation 403: The server on which the source space is located transmits a connection creation request to a gateway.

The connection creation request carries a destination space ID.

Operation 404: The gateway creates a connection to a server on which the destination space is located.

Operation 405: The server on which the destination space is located returns a connection creation completion message to the gateway.

The connection creation completion message is configured for indicating that a connection has been created between the gateway and the server on which the destination space is located.

Operation 406: The gateway returns a connection creation completion message to the server on which the source space is located.

Operation 407: The server on which the source space is located starts an entity authorization transfer process.

The server on which the source space is located may package data such as a unique ID of the entity object, an attribute data set of the entity object, and a private data set of the entity object.

Operation 408: The server on which the source space is located transmits a transfer message.

The transfer message is configured for indicating the server on which the destination space is located to perform authorization transfer.

Operation 409: The server on which the destination space is located performs authorization transfer.

Operation 410: The server on which the destination space is located transmits a transfer state end message.

The transfer state end message is configured for indicating that the server on which the destination space is located has completed the authorization transfer.

Operation 411: The server on which the source space is located transmits a transfer start message to the gateway.

The transfer start message carries the destination space ID, to indicate the gateway to enable network communication between the control client, the gateway, and the destination space.

Operation 412: The gateway records space information of authorization transfer switching, and transmits a transfer start message to the client.

The space information of authorization transfer switching includes the destination space ID of the authorization transfer of the entity object and a corresponding connection relationship.

Operation 413: The client locally switches a proxy authorization connection.

For example, the client switches the proxy authorization connection to a network connection that is connected to the destination space and that is indicated by the gateway.

Operation 414: The gateway transmits a client authorization transfer success message to the server on which the destination space is located.

The client authorization transfer success message is configured for indicating that the client authorization transfer is successful.

Operation 415: The server on which the destination space is located resets a binding relationship.

For example, on the server on which the destination space is located, a connection relationship between the client-controlled entity object, the destination space, and the gateway is reset and bound. In this way, network communication between the control client, the gateway, and the destination space is enabled, to continue to control the entity in the destination space.

### (3) Proxy Recycle During Entity Object Transfer

FIG. 11 is a schematic flowchart of a proxy recycle method according to an example of this application. Descriptions are provided with reference to operations shown in FIG. 11. A proxy recycle event supports initiation by a plurality of modules in a metaverse, for example, a view module (a module configured to control a field of view in a virtual scene) and a scene module.

Operation 501: Determine whether an entity replica corresponding to an entity object exists. When an entity replica corresponding to the entity object already exists, operation 502 is performed. When no entity replica corresponding to the entity object exists, the process ends.

Operation 502: Determine whether a reference count meets a condition. When the condition is met, operation 503 is performed. When the condition is not met, the process ends.

After a proxy recycle event is triggered, when a count value of a reference count corresponding to a module that triggers the proxy recycle event is 1, the reference count meets the condition.

Operation 503: Decrease the reference count.

An underlying system maintains an entity replica by using a reference count, and pushes forward a subsequent process by using the entity replica and the reference count carried in the entity replica. After the proxy recycle event is triggered, the entity replica needs to be recycled, and certainly, the reference count needs to be decreased.

Operation 504: Determine whether a count value of the reference count is zero. When the count value of the reference count is zero, operation 505 is performed. When the count value of the reference count is not zero, operation 507 is performed.

When the count value of the reference count is zero, a remote entity replica needs to be actually recycled.

Operation 505: Set a status of the entity object of the entity replica to pending recycle.

Operation 506: Add the entity object to a proxy recycle queue.

After the entity object is added to the proxy recycle queue, the entity object waits for polling of the proxy recycle queue.

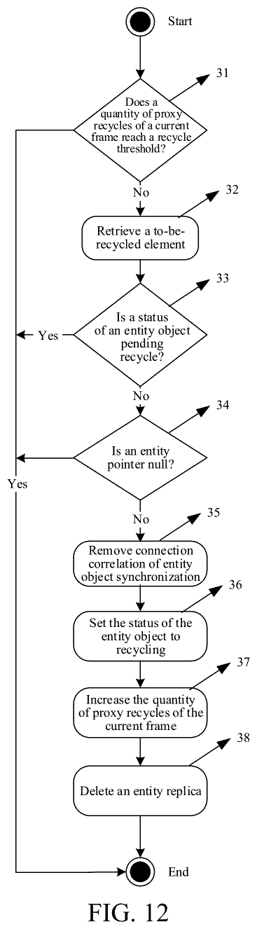

FIG. 12 is a schematic flowchart of polling of a proxy recycle queue according to an example of this application. Descriptions are provided with reference to operations shown in FIG. 12.

Operation 31: Determine whether a quantity of proxy recycles of a current frame reaches a recycle threshold. When the quantity of proxy recycles of the current frame does not reach the recycle threshold, operation 32 is performed. When the quantity of proxy recycles of the current frame reaches the recycle threshold, the process ends.

A frame is configured for indicating a time period, for example, current 15 milliseconds. The quantity of proxy recycles is configured for indicating a quantity of times of performing proxy recycle.

Operation 32: Retrieve a to-be-recycled element from the proxy recycle queue.

During each time of polling, when the quantity of proxy recycles of the current frame does not reach the recycle threshold, to-be-recycled elements (to be specific, IDs of entity objects in the proxy recycle queue, configured for indicating to recycle an entity replica) are sequentially retrieved from the proxy recycle queue.

Operation 33: Determine whether a status of an entity object is pending recycle. When the status of the entity object is not pending recycle, operation 24 is performed. When the status of the entity object is pending recycle, the process ends.

Operation 34: Determine whether an entity object pointer is null. When the entity object pointer is not null, operation 35 is performed. When the entity object pointer is null, the process ends.

The entity object pointer points to an entity replica of the entity object. When the entity object pointer is null, no entity replica exists in a source space.

Whether proxy recycle needs to be performed on an entity replica is determined based on the status, the entity object pointer, and the like.

Operation 35: Remove connection correlation of entity object synchronization.

The removing connection correlation of entity object synchronization is to enable a synchronization module not to allow the entity object to perform network communication from the source space to a destination space.

Operation 36: Set the status of the entity object to recycling.

Operation 37: Increase the quantity of proxy recycles of the current frame.

Operation 38: Recycle an entity replica.

For example, a synchronization module initiates a proxy recycle operation, and deletes entity replica data in the source space and the destination space. To be specific, entity replica data of a server simulated proxy role is deleted, where an ID of the entity replica data is (a unique ID of the entity object+a source space ID), a local space ID of the entity object is the source space ID, an owner space ID of the entity object is a destination space ID, a local role is the server simulated proxy role, and an owner role is an authority role; and entity replica data of an authority role is deleted, where an ID of the entity replica data is (a unique ID of the entity object+a destination space ID), a local space ID of the entity object is the destination space ID, an owner space ID of the entity object is the destination space ID, a local role is the authority role, and an owner role is the authority role.

Operation 507: Broadcast a recycle success event.

If the recycle success event is broadcast, it is considered that a proxy recycle event of a module that invokes the proxy recycle event is completed, and an initial state is restored.

To sum up, in the data processing method for a virtual scene provided in the examples of this application, a control requirement for an entity replica is supported. Entity object transfer is divided into three stages, and an entire transfer process is smoothed, to increase a fault tolerance rate of transfer of entity object data, and reduce a risk of an entity object transfer failure. Complete entity replica data is provided at an underlying layer of a system. For various exceptions occurring during entity object transfer, data determining may be performed to locate and correct the exceptions, to avoid chaotic behavior.

The data processing method for a virtual scene provided in the examples of this application is described with reference to the application and implementation of the electronic device provided in the examples of this application. The following further describes how the modules in the data processing apparatus 555 for a virtual scene provided in the examples of this application cooperate with each other to implement an entity object transfer solution.

The obtaining module 5551 is configured to display a virtual scene, the virtual scene including an entity object, recognize the entity object from the virtual scene, and determine a source space and a destination space for transferring the entity object. The proxy creation module 5552 is configured to perform proxy creation on the entity object in the source space to obtain a first entity replica of the entity object, and perform proxy creation on the entity object in the destination space to obtain a second entity replica of the entity object, behavior data of the second entity replica being synchronized with behavior data of the first entity replica. The authorization transfer module 5553 is configured to perform authorization transfer on the first entity replica and the second entity replica to obtain a first transferred entity replica and a second transferred entity replica. The proxy recycle module 5554 is configured to perform proxy recycle on the first transferred entity replica and the second transferred entity replica.

In some examples, an attribute of the first entity replica includes a unique ID, a local space ID, an owner space ID, and a local role. The proxy creation module 5552 is further configured to: generate a first initial entity replica having the attribute in the source space; and reset the unique ID of the first initial entity replica to an ID of the entity object, reset the local space ID to the source space, reset the owner space ID to the source space, and reset the local role to an authority role, to obtain the first entity replica, behavior data of the entity object being synchronized with behavior data of an entity replica of the authority role.

In some examples, before authorization transfer is performed on the first entity replica and the second entity replica, the proxy creation module 5552 is further configured to: when the first entity replica already exists in the source space and a count value of a reference count of a module that invokes proxy creation is zero, increase the count value of the reference count of the module that invokes proxy creation, the reference count being configured for representing a progress of the proxy creation.

In some examples, an attribute of the second entity replica includes a unique ID, a local space ID, an owner space ID, and a local role. The proxy creation module 5552 is further configured to: generate a second initial entity replica having the attribute in the destination space; and reset the unique ID of the second initial entity replica to the ID of the entity object, reset the local space ID to the destination space, reset the owner space ID to the source space, and reset the local role to a server simulated proxy role, to obtain the second entity replica.

In some examples, the proxy creation module 5552 is further configured to: add the entity object to a proxy creation queue, and set a status of the entity object in the proxy creation queue to pending creation; when it is determined, during periodic polling of the proxy creation queue, that a quantity of proxy creations does not reach a creation threshold and a status of an entity object found through polling in the proxy creation queue is pending creation, enable network communication between the source space and the destination space, update the status of the entity object found through polling in the proxy creation queue to creating, the network communication being configured for performing an operation of performing proxy creation on the entity object based on the destination space, and increase the quantity of proxy creations; and when the second entity replica has been created in the destination space through proxy creation, update the status of the entity object in the proxy creation queue to created.

In some examples, before authorization transfer is performed on the first entity replica and the second entity replica to obtain the first transferred entity replica and the second transferred entity replica, the proxy creation module 5552 is further configured to perform proxy attribute creation on the entity object in the source space based on the destination space, to obtain attribute data of a first proxy object, the second entity replica being a first proxy object of the first entity replica, and the attribute data being configured for locating a space in which the first proxy object of the first entity replica is located.

In some examples, the attribute data includes a unique ID, a local space ID, an owner space ID, and a local role. The proxy creation module 5552 is further configured to: generate initial attribute data in the source space; and reset the unique ID included in the initial attribute data to the ID of the entity object, reset the local space ID to the destination space, reset the owner space ID to the source space, and reset the local role to a server simulated proxy role, to obtain the attribute data of the first proxy object.

In some examples, an attribute of the first entity replica and an attribute of the second entity replica both include an owner space ID and a local role. The authorization transfer module 5553 is further configured to: modify the owner space ID of the first entity replica to the destination space, and modify the local role to a server simulated proxy role, to obtain the first transferred entity replica; and modify the owner space ID of the second entity replica to the destination space, and modify the local role to an authority role, to obtain the second transferred entity replica.

In some examples, before authorization transfer is performed on the first entity replica and the second entity replica to obtain the first transferred entity replica and the second transferred entity replica, the authorization transfer module 5553 is further configured to: when the entity object meets a queue processing condition, add the entity object to a transfer queue, the queue processing condition including that the entity object is not a client-controlled entity object and is not processed in the transfer queue; and when it is determined, during periodic polling of the transfer queue, that a quantity of transfers does not reach a transfer threshold and a latest destination space of the entity object is the same as the destination space, perform authorization transfer on the first entity replica and the second entity replica to obtain the first transferred entity replica and the second transferred entity replica.

In some examples, before proxy recycle is performed on the first entity replica and the second entity replica that have been transferred, the authorization transfer module 5553 is further configured to perform proxy attribute creation on the second transferred entity replica in the destination space based on the source space, to obtain attribute data of a second proxy object.

The first transferred entity replica is a second proxy object of the second transferred entity replica, and the attribute data is configured for locating a space in which the second proxy object of the second transferred entity replica is located.

In some examples, when the entity object is a client-controlled entity object, before authorization transfer is performed on the first entity replica and the second entity replica to obtain the first transferred entity replica and the second transferred entity replica, the authorization transfer module 5553 is further configured to create, through a gateway, a network connection between the gateway and a server on which the destination space is located. After authorization transfer is performed on the first entity replica and the second entity replica, the method further includes: transmitting, through the gateway, a transfer start message to the client that controls the entity object, the transfer start message carrying a connection relationship of the network connection, and the transfer start message being configured for indicating the client to switch a proxy authorization connection to the network connection; receiving, through the gateway, a switching message transmitted by the client, the switching message indicating that the client has switched the proxy authorization connection to the network connection; and transmitting, through the gateway, an authorization transfer success message to the server on which the destination space is located, the authorization transfer success message being configured for indicating the server on which the destination space is located to bind the client-controlled entity object to the network connection, to enable network communication between the client, the gateway, and the server on which the destination space is located.

In some examples, before proxy recycle is performed on the first entity replica and the second entity replica that have been transferred, the proxy recycle module 5554 is further configured to: when the first transferred entity replica already exists in the source space and a count value of a reference count of a module that runs the virtual scene is not zero, decrease a count value of a reference count of a module that invokes proxy recycle; when the count value of the reference count of the module is decreased to zero, set a status of the entity object to pending recycle, and add the entity object to a proxy recycle queue; when it is determined, during periodic polling of the proxy recycle queue, that a quantity of proxy recycles does not reach a recycle threshold and a status of the entity object found through polling is pending recycle, disable network communication between the source space and the destination space, and set the status of the entity object found through polling to recycling; and after the status of the entity object found through polling is set to recycling, increase the quantity of proxy recycles, and perform a proxy recycle operation on the first transferred entity replica and the second transferred entity replica.

The examples of this application provide a computer program product. The computer program product includes a computer program or computer-executable instructions. The computer program or the computer-executable instructions are stored in a computer-readable storage medium. A processor of an electronic device reads the computer program or the computer-executable instructions from the computer-readable storage medium, and the processor executes the computer program or the computer-executable instructions, so that the electronic device performs the data processing method for a virtual scene in the examples of this application.

The examples of this application provide a computer-readable storage medium, having computer-executable instructions or a computer program stored therein. When the computer-executable instructions or the computer program is executed by a processor, the processor is enabled to perform the data processing method for a virtual scene provided in the examples of this application, for example, the data processing method for a virtual scene shown in FIG. 3A.

In some examples, the computer-readable storage medium may be a memory such as an FRAM, a ROM, a PROM, an EPROM, an EEPROM, a flash memory, a magnetic memory, a compact disc, or a CD-ROM; or may be various devices including one of or any combination of the foregoing memories.

In some examples, the computer-executable instructions may be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in a plurality of collaborative files (for example, be stored in files of one or more modules, subprograms, or code parts).

In an example, the computer-executable instructions may be deployed on one electronic device for execution, or may be executed on a plurality of electronic devices at one location, or may be executed on a plurality of electronic devices that are distributed at a plurality of locations and that are interconnected through a communication network.

Related data such as user information is involved in the examples of this application. When the examples of this application are applied to a specific product or technology, user permission or consent is required, and collection, use, and processing of related data need to comply with related laws, regulations, and standards in related countries and regions.

The foregoing descriptions are merely examples of this application and are not intended to limit the protection scope of this application. Any modification, equivalent replacement, or improvement made without departing from the spirit and scope of this application shall fall within the protection scope of this application.

What is claimed is:

1. A data processing method comprising:
displaying a virtual scene comprising an entity object;
determining a source space and a destination space for transferring the entity object;
performing, by a computing device, proxy creation on the entity object in the source space to obtain a first entity replica of the entity object;
performing proxy creation on the entity object in the destination space to obtain a second entity replica of the entity object;
synchronizing behavior data of the second entity replica with behavior data of the first entity replica;
performing authorization transfer on the first entity replica and the second entity replica to obtain a first transferred entity replica and a second transferred entity replica; and
performing proxy recycle on the first transferred entity replica and the second transferred entity replica.

2. The method according to claim 1, wherein:
an attribute of the first entity replica comprises a unique ID, a local space ID, an owner space ID, and a local role; and
the performing proxy creation on the entity object in the source space to obtain the first entity replica of the entity object comprises:
generating a first initial entity replica having the attribute in the source space;
resetting the unique ID of the first initial entity replica to an ID of the entity object, resetting the local space ID to the source space, resetting the owner space ID to the source space, and resetting the local role to an authority role, to obtain the first entity replica; and
synchronizing behavior data of the entity object with the behavior data of the first entity replica.

3. The method according to claim 1, wherein before the performing proxy creation on the entity object in the source space to obtain the first entity replica of the entity object, the method further comprises:
when the first entity replica exists in the source space and a count value of a reference count of a module that invokes proxy creation is zero, increasing the count value of the reference count of the module, and wherein the reference count represents a progress of the proxy creation.

4. The method according to claim 1, wherein:
an attribute of the second entity replica comprises a unique ID, a local space ID, an owner space ID, and a local role; and
the performing proxy creation on the entity object in the destination space to obtain the second entity replica of the entity object comprises:
generating a second initial entity replica having the attribute in the destination space; and
resetting the unique ID of the second initial entity replica to an ID of the entity object, resetting the local space ID to the destination space, resetting the owner space ID to the source space, and resetting the local role to a server simulated proxy role, to obtain the second entity replica.

5. The method according to claim 1, wherein after the performing proxy creation on the entity object in the source space to obtain the first entity replica of the entity object, the method further comprises:
adding the entity object to a proxy creation queue, and setting a status of the entity object in the proxy creation queue to pending creation;
based on a determination, during periodic polling of the proxy creation queue, that a quantity of proxy creations does not reach a creation threshold and a status of an entity object found through polling in the proxy creation queue is pending creation, enabling network communication between the source space and the destination space, updating the status of the entity object found through polling in the proxy creation queue to creating, and increasing the quantity of proxy creations, wherein the network communication is configured to perform an operation of performing proxy creation on the entity object based on the destination space; and
based on a determination that the second entity replica has been created in the destination space through proxy creation, updating the status of the entity object in the proxy creation queue to created.

6. The method according to claim 1, wherein before the performing authorization transfer on the first entity replica and the second entity replica to obtain the first transferred entity replica and the second transferred entity replica, the method further comprises:
performing proxy attribute creation on the entity object in the source space based on the destination space, to obtain attribute data of a first proxy object, wherein the second entity replica is a first proxy object of the first entity replica, and the attribute data indicates a location of a space in which the first proxy object of the first entity replica is located.

7. The method according to claim 6, wherein:
the attribute data comprises a unique ID, a local space ID, an owner space ID, and a local role; and
the performing proxy attribute creation on the entity object in the source space based on the destination space, to obtain attribute data of the first proxy object comprises:
generating initial attribute data in the source space; and
resetting the unique ID comprised in the initial attribute data to an ID of the entity object, resetting the local space ID to the destination space, resetting the owner space ID to the source space, and resetting the local role to a server simulated proxy role, to obtain the attribute data of the first proxy object.

8. The method according to claim 1, wherein:
an attribute of the first entity replica and an attribute of the second entity replica both comprise an owner space ID and a local role; and
the performing authorization transfer on the first entity replica and the second entity replica to obtain the first transferred entity replica and the second transferred entity replica comprises:
modifying the owner space ID of the first entity replica to the destination space, and modifying the local role to a server simulated proxy role, to obtain the first transferred entity replica; and
modifying the owner space ID of the second entity replica to the destination space, and modifying the local role to an authority role, to obtain the second transferred entity replica.

9. The method according to claim 1, wherein:
before the performing authorization transfer on the first entity replica and the second entity replica to obtain the first transferred entity replica and the second transferred entity replica, the method further comprises:
based on that the entity object meets a queue processing condition, adding the entity object to a transfer queue, the queue processing condition comprising that the entity object is not a client-controlled entity object and the entity object is not processed in the transfer queue; and
the performing authorization transfer on the first entity replica and the second entity replica to obtain the first transferred entity replica and the second transferred entity replica comprises:
based on a determination, during periodic polling of the transfer queue, that a quantity of transfers does not reach a transfer threshold and a latest destination space of the entity object is the same as the destination space, performing authorization transfer on the first entity replica and the second entity replica to obtain the first transferred entity replica and the second transferred entity replica.

10. The method according to claim 1, wherein before the performing proxy recycle on the first transferred entity replica and the second transferred entity replica, the method further comprises:
performing proxy attribute creation on the second transferred entity replica in the destination space based on the source space, to obtain attribute data of a second proxy object, wherein the first transferred entity replica is a second proxy object of the second transferred entity replica, and the attribute data indicates a location of a space in which the second proxy object of the second transferred entity replica is located.

11. The method according to claim 1, wherein:
if the entity object is a client-controlled entity object, before the performing authorization transfer on the first entity replica and the second entity replica to obtain the first transferred entity replica and the second transferred entity replica, the method further comprises:
creating, through a gateway, a network connection between the gateway and a server on which the destination space is located; and
after the performing authorization transfer on the first entity replica and the second entity replica to obtain a first transferred entity replica and a second transferred entity replica, the method further comprises:
transmitting, through the gateway, a transfer start message to the client that controls the entity object, the transfer start message carrying a connection relationship of the network connection, the transfer start message indicating the client to switch a proxy authorization connection to the network connection;
receiving, through the gateway, a switching message transmitted by the client, the switching message indicating that the client has switched the proxy authorization connection to the network connection; and
transmitting, through the gateway, an authorization transfer success message to the server, the authorization transfer success message indicating the server on which the destination space is located to bind the client-controlled entity object to the network connection, to enable network communication between the client, the gateway, and the server.

12. The method according to claim 1, wherein before the performing proxy recycle on the first transferred entity replica and the second transferred entity replica, the method further comprises:
based on that the first transferred entity replica already exists in the source space and a count value of a reference count of a module that runs the virtual scene is not zero, decreasing a count value of a reference count of a module that invokes proxy recycle;
based on that the count value of the reference count of the module is decreased to zero, setting a status of the entity object to pending recycle, and adding the entity object to a proxy recycle queue;
based on a determination, during periodic polling of the proxy recycle queue, that a quantity of proxy recycles does not reach a recycle threshold and a status of the entity object found through polling is pending recycle, disabling network communication between the source space and the destination space, and setting the status of the entity object found through polling to recycling; and
after the status of the entity object found through polling is set to recycling, increasing the quantity of proxy recycles, and performing a proxy recycle operation on the first transferred entity replica and the second transferred entity replica.

13. An apparatus comprising:
one or more processors; and
memory storing instructions that, when executed by the one or more processors, cause the apparatus to:
display a virtual scene comprising an entity object;
determine a source space and a destination space for transferring the entity object;
perform, by a computing device, proxy creation on the entity object in the source space to obtain a first entity replica of the entity object;
perform proxy creation on the entity object in the destination space to obtain a second entity replica of the entity object;
synchronize behavior data of the second entity replica with behavior data of the first entity replica;
perform authorization transfer on the first entity replica and the second entity replica to obtain a first transferred entity replica and a second transferred entity replica; and
perform proxy recycle on the first transferred entity replica and the second transferred entity replica.

14. The apparatus according to claim 13, wherein an attribute of the first entity replica comprises a unique ID, a local space ID, an owner space ID, and a local role; and
the instructions, when executed by the one or more processors, cause the apparatus to perform proxy creation on the entity object in the source space to obtain the first entity replica of the entity object by:
generating a first initial entity replica having the attribute in the source space;
resetting the unique ID of the first initial entity replica to an ID of the entity object, resetting the local space ID to the source space, resetting the owner space ID to the source space, and resetting the local role to an authority role, to obtain the first entity replica; and
synchronizing behavior data of the entity object with the behavior data of the first entity replica.

15. The apparatus according to claim 13, wherein before performing proxy creation on the entity object in the source space to obtain the first entity replica of the entity object, the instructions, when executed by the one or more processors, cause the apparatus to:
when the first entity replica already exists in the source space and a count value of a reference count of a module that invokes proxy creation is zero, increase the count value of the reference count of the module, and wherein the reference count represents a progress of the proxy creation.

16. The apparatus according to claim 13, wherein an attribute of the second entity replica comprises a unique ID, a local space ID, an owner space ID, and a local role; and
wherein the instructions, when executed by the one or more processors, cause the apparatus to perform proxy creation on the entity object in the destination space to obtain the second entity replica of the entity object by:
generating a second initial entity replica having the attribute in the destination space; and
resetting the unique ID of the second initial entity replica to an ID of the entity object, resetting the local space ID to the destination space, resetting the owner space ID to the source space, and resetting the local role to a server simulated proxy role, to obtain the second entity replica.

17. The apparatus according to claim 13, wherein after performing proxy creation on the entity object in the source space to obtain the first entity replica of the entity object, and wherein the instructions, when executed by the one or more processors, cause the apparatus to:
add the entity object to a proxy creation queue, and setting a status of the entity object in the proxy creation queue to pending creation;
based on a determination, during periodic polling of the proxy creation queue, that a quantity of proxy creations does not reach a creation threshold and a status of an entity object found through polling in the proxy creation queue is pending creation, enable network communication between the source space and the destination space, update the status of the entity object found through polling in the proxy creation queue to creating, and increase the quantity of proxy creations, wherein the network communication is configured to perform an operation of performing proxy creation on the entity object based on the destination space; and
based on a determination that the second entity replica has been created in the destination space through proxy creation, update the status of the entity object in the proxy creation queue to created.

18. The apparatus according to claim 13, wherein before performing authorization transfer on the first entity replica and the second entity replica to obtain the first transferred entity replica and the second transferred entity replica, wherein the instructions, when executed by the one or more processors, cause the apparatus to:
perform proxy attribute creation on the entity object in the source space based on the destination space, to obtain attribute data of a first proxy object, and wherein the second entity replica is a first proxy object of the first entity replica, and the attribute data indicates a location of a space in which the first proxy object of the first entity replica is located.

19. The apparatus according to claim 13, wherein:
an attribute of the first entity replica and an attribute of the second entity replica both comprise an owner space ID and a local role; and
the instructions, when executed by the one or more processors, cause the apparatus to perform authorization transfer on the first entity replica and the second entity replica to obtain the first transferred entity replica and the second transferred entity replica by:
modifying the owner space ID of the first entity replica to the destination space, and modifying the local role to a server simulated proxy role, to obtain the first transferred entity replica; and
modifying the owner space ID of the second entity replica to the destination space, and modifying the local role to an authority role, to obtain the second transferred entity replica.

20. A non-transitory computer-readable medium storing instructions that, when executed, cause:
displaying a virtual scene comprising an entity object;
determining a source space and a destination space for transferring the entity object;
performing proxy creation on the entity object in the source space to obtain a first entity replica of the entity object;
performing proxy creation on the entity object in the destination space to obtain a second entity replica of the entity object;
synchronizing behavior data of the second entity replica with behavior data of the first entity replica;
performing authorization transfer on the first entity replica and the second entity replica to obtain a first transferred entity replica and a second transferred entity replica; and
performing proxy recycle on the first transferred entity replica and the second transferred entity replica.
